(19) United States
(12) Patent Application Publication
(10) Pub. No.: US 2002/0034404 A1
(43) Pub. Date: Mar. 21, 2002

(54) Cartridge having developer supply opening and image forming apparatus usable therewith

(76) Inventors: Hisayoshi Kojima, Mishima-shi (JP); Hironobu Isobe, Numazu-shi (JP); Kenji Matsuda, Numazu-shi (JP); Takashi Yahagi, Toride-shi (JP)

Correspondence Address: FITZPATRICK CELLA HARPER & SCINTO, 30 ROCKEFELLER PLAZA, NEW YORK, NY, 10112, US

(21) Appl. No.: 09/942,575

(22) Filed: Aug. 31, 2001

(30) Foreign Application Priority Data
Sep. 1, 2000 (JP) 2000/266022
Jan. 25, 2001 (JP) 2001/016922

(51) Int. Cl. G03G 15/08

(52) U.S. Cl. 399/258

(57) ABSTRACT

A unit detachably mountable to an image forming apparatus includes a developer accommodating portion having a developer inlet hole; a first opening and closing member for opening and closing the inlet hole; and a second opening and closing member for opening and closing the inlet hole, the second opening and closing member being movable above the first opening and closing member.

### FIELD OF THE INVENTION AND RELATED ART

The present invention relates to a cartridge having a developer supply opening or inlet hole detachably mountable to an image forming apparatus such as a copying machine or a printer using an electrophotographic recording process or an electrostatic recording process or the like, and an image forming apparatus to which the cartridge is detachable mountable.

Recently, many copying machines and printers employ a so-called cartridge type with which the maintenance operation is easy.

For example, in the case of a printer using an electrophotographic recording technique, a photosensitve member and a developing device are contained as a unit in the cartridge which is detachably mountable to the main assembly of the printer; or the photosensitive member and a cleaning device are contained as a unit in a cartridge in which a developing device constitutes another cartridge which is detachably mountable to the main assembly of the printer. There are various types of cartridges.

Among them, there is a type in which the developing device and the developer supply container are separate so that developer supply container can be independently exchangeable, thus permitting the developer which is a consumption material to be replenished. With this type, it is not necessary to exchange the constituent-element in the developing device such as a developing roller which has a relatively long service life, for each replenishment, and therefore, the type is preferable from the economical standpoint, and in addition, since the size of the cartridge may be small, the cartridge can be relatively easily exchanged.

However, when the cartridge is taken out of the main assembly of the printer, care should be taken to prevent the users hand from being contaminated.

Japanese Patent Application 11-337265 purposes that toner discharge opening or outlet hole of the toner cartridge and a toner receiving port of the process cartridge are brought into commutation with each other in interrelation with mounting of the toner cartridge and the process cartridge to the main assembly of the image forming apparatus. As shown in FIG. 33, the toner outlet hole 23 of the toner cartridge is provided with a T shutter 27 having a substantially round configuration. A shutter cover 19, which is provided in the process cartridge, is provided with projections 19b, 19c. By doing so, when the toner cartridge and the process cartridge are mounted to or demoted from the main assembly of the image forming apparatus, the toner outlet hole 23 of the toner cartridge is closed by the T shutter 27 assuredly. More particularly, when the toner cartridge is inserted in the direction of arrow C into the main assembly of the image forming apparatus, the T shutter 27 (chain line) disposed in the bottom portion 26 of the container of the toner cartridge, is moved into the state indicated by solid line in the direction of arrow D by rotation about a shaft 28a while a projection 19b of the process cartridge is in engagement with a groove portion 27b. Thus, the toner outlet hole 23 is opened. FIG. 34 shows a behavior of rotation of the T shutter 27. When it is moved in the direction of arrow C, the T shutter 27 rotates so that opening 27a also moves.

On the other hand, a P shutter 18′ (chain line) which closes the receiving port 16 of the process cartridge, when the process cartridge is inserted into the main assembly of the image forming apparatus (in the direction of arrow A), a groove portion 18′ b and a projection 36 provided in the image forming apparatus are engaged and rotated in the direction indicated by an arrow B, so that P shutter 18 takes the position indicated by the solid line, thus opening of the receiving port 16.

On the other hand, when the toner cartridge is demounted from what the mounted from the main assembly of the image forming apparatus, the T shutter 27 rotates in the direction of arrow D about the shaft 28a with the engagement between the projection 19c of the process cartridge and the groove portion 27b, thus closing the toner outlet hole 23. In the demounting operation of the process cartridge, the operations are reverse.

With this technique disclosed in said Japanese Patent Application 11-337265, the shutter of the toner outlet hole of the toner cartridge can be closed all being the demounting operation of the process cartridge or the toner cartridge. Even if the toner cartridge and the process cartridge are independently demounted from the main assembly of the image forming apparatus, the toner outlet hole can be opened and closed. In addition, the operations are assured because the opening and closing operations are carried out without use of urging means such as a spring, but are carried out by the demounting operation of the cartridge.

However, since the shutter of the toner cartridge rotates while displacing, and therefore, the track of the opening is elongated in the mounting-and-demounting direction (the direction indicated by the arrow C in FIG. 33), with the result of a higher possibility of toner leakage and scattering.

### SUMMARY OF THE INVENTION

Accordingly, it is a principal object of the present invention to provide a cartridge and an image forming apparatus to which the cartridge is detachably mountable, in which the possibility of contamination of the users hands in lessened.

It is another object of the present invention to provide a cartridge having a proper size of a developer inlet hole and an image forming apparatus to which the cartridge is detachably mountable.

It is a further object of the present invention to provide a cartridge and an image forming apparatus to which the cartridge is detachably mountable, in which the cartridge is provided with a developer inlet hole suitable to the size of the developer outlet hole of the developer supply container.

According to an aspect of the present invention there is provided a unit detachably mountable to an image forming apparatus, including a developer accommodating portion having a developer inlet hole; a first opening and closing member for opening and closing said inlet hole; and a second opening and closing member for opening and closing said inlet hole, said second opening and closing member being movable above said first opening and closing member.

According to another aspect of the present invention, there is provided an image forming apparatus comprising a unit detachably mountable to a main assembly of said apparatus, said unit including a developer accommodating portion having a developer inlet hole and a first opening and closing member for opening and closing said inlet hole, and a second opening and closing member, movable above said first opening and closing member, for opening and closing said inlet hole; and an engaging portion for being contacted by a predetermined portion of said unit when said unit is mounted to the main assembly of the apparatus, wherein said opening and closing member is moved by the contact of the determined portion to said engaging portion.

According to a further aspect of the present invention, there is provided a unit detachably mountable to an image forming apparatus, comprising a developer accommodating portion having a developer inlet hole; an opening and closing member for opening and closing said inlet hole; wherein said inlet hole has a substantially parallelogram shape having an inner angle which is not right angle.

According to a further aspect of the present invention, there is provided an image forming apparatus comprising a unit detachably mountable to a main assembly of said apparatus, said unit including a developer accommodating portion having a having and an opening and closing member for opening and closing said inlet hole; and an engaging portion for being contacted by a predetermined portion of said unit when said unit is mounted to the main assembly of the apparatus, wherein said opening and closing member is moved by the contact of the determined portion to said engaging portion; wherein said inlet hole has a substantially parallelogram shape having an inner angle which is not right angle.

According to a further aspect of the present invention, there is provided an image forming apparatus comprising: a first unit detachably mountable to a main assembly of said operators, wherein said first unit including a developer outlet hole and a movable shutter having a hole capable of exposing said outlet hole; a second unit detachably mountable to the main assembly of said apparatus, said second unit having a developer inlet hole for permitting passage of the developer falling from the outlet hole; wherein said shutter is movable in response to a relative motion between said first unit and said second unit; wherein a configuration of said inlet hole is along a track of an overlapped portion of said outlet hole and said hole which changes with mounting or demounting operation of said first or second unit.

These and other objects, features and advantages of the present invention will become more apparent upon a consideration of the following description of the preferred embodiment of the present invention taken in conjunction with the accompanying drawings.

### BRIEF DESCRIPTION OF THE DRAWINGS

FIG. 1 is a longitudinal sectional view of a main assembly of a color electrophotographic image forming apparatus according to an embodiment of the present invention.

FIG. 2 is longitudinal sectional views of a process cartridge and a toner supply container according to an embodiment of the present invention.

FIG. 3 is a schematic perspective view wherein a front door of an image forming apparatus is opened according to an embodiment of the present invention.

FIG. 4 is a cross-sectional view of a process cartridge (longitudinal section of the process cartridge) according to an embodiment of the present invention.

FIG. 5 is longitudinal sectional views of a toner supply container and a process cartridge according to an embodiment of the present invention.

FIG. 6 is a perspective view of a process cartridge in which a toner inlet hole shutter and a toner inlet hole cover are closed, as seen from the rear side.

FIG. 7 is a perspective view, as seen from the rear side, of the process cartridge and which the toner inlet hole shutter and the toner inlet hole cover are opened.

FIG. 8 is a perspective view, as seen from the rear side, of the process cartridge in which a member above a shutter opening and closing mechanism is removed to expose the shutter opening and closing mechanism.

FIG. 9 is a perspective view, as seen from a front side, of a process cartridge in which the toner inlet hole shutter and the toner inlet hole cover are opened, and in which the shutter opening and closing mechanism are exposed.

FIG. 10 illustrates opening and closing operations of the toner inlet hole shutter, the inlet hole cover and the laser shutter of the process cartridge.

FIG. 11 shows an opening and closing operation of the shutter of the toner supply container.

FIG. 12 is a longitudinal sectional view of a shutter portion of a process cartridge.

FIG. 13 is a top plan view with the process cartridge in which the inlet hole shutter is removed, according to an embodiment of the present invention.

FIG. 14 illustrates a front side of the inlet hole shutter (a), and a rear side thereof (b).

FIG. 15 in a perspective view of a shutter opening and closing cam.

FIG. 16 is a perspective view illustrating a relation between the shutter opening and closing cam and the shutter when the inlet hole is closed by the inlet hole shutter.

FIG. 17 is a perspective view illustrating a relation between the inlet hole shutter and the shutter opening and closing cam in the state between the states shown in FIG. 16 FIG. 17.

FIG. 18 is a perspective view illustrating a relation between the shutter opening and closing cam and the shutter when the inlet hole is not closed by the inlet hole shutter.

FIG. 19 in a schematic view illustrating a relation between opening and closing of the laser shutter and the shutter opening and closing cam.

FIG. 20 is a top plan view of a first pushing member (a) and a side view of the first pushing member.

FIG. 21 is a schematic view illustrating a relation between the inlet hole cover and the shutter opening and closing cam.

FIG. 22 is a side view of an outlet hole cover of a toner supply container illustrating an operation thereof.

FIG. 23 is a partially enlarged perspective view illustrating an outlet hole of the toner supply container according to an embodiment of the present invention.

FIG. 24 is a perspective view of a pushing member of a toner supply container.

FIG. 25 is a top view of a shutter of a process cartridge according to an embodiment of the present invention.

FIG. 26 is a schematic longitudinal sectional view of a color electrophotographic printer according to an embodiment of the present invention.

FIG. 27 is a schematic perspective view of a color electrophotographic printer according to an embodiment of the present invention.

FIG. 28 is a schematic perspective view of a color electrophotographic printer according to an embodiment of the present invention.

FIG. 29 is a schematic longitudinal sectional view of a neighborhood of a P shutter of a process cartridge according to an embodiment of the present invention.

FIG. 30 is a schematic perspective view illustrating a shutter of a process cartridge and an opening and closing operation of a shutter of a toner cartridge according to an embodiment of the present invention.

FIG. 31 is a top view illustrating change of a configuration of a communicating portion according to an embodiment of the present invention.

FIG. 32 is a top view of a shutter of a conventional process cartridge.

FIG. 33 is a schematic perspective view illustrating a shutter of a conventional process cartridge and an opening and closing operation of a shutter of a toner cartridge.

FIG. 34 is a top view showing a track of a shutter of a toner cartridge.

### THE PREFERRED EMBODIMENTS OF THE INVENTION

Hereinafter, the present invention will be described with reference to an electrophotographic color image forming apparatus. In the following description of the present invention, the lengthwise direction means the direction parallel to the axial direction of an electrophotographic photoconductive member (which hereinafter will be referred to as photoconductive drum 2). Further, with respect to the direction in which a cartridge is inserted into an electrophotographic image forming apparatus, the leading end will be referred to as the rear side, and with respect to the direction in which the cartridge is pulled out of the apparatus, the leading end will be referred to as the front side. Further, the top and bottom sides of a cartridge means the top and bottom sides of the cartridge when the cartridge is in the proper position in the apparatus main assembly.

General Description of Image Forming Apparatus

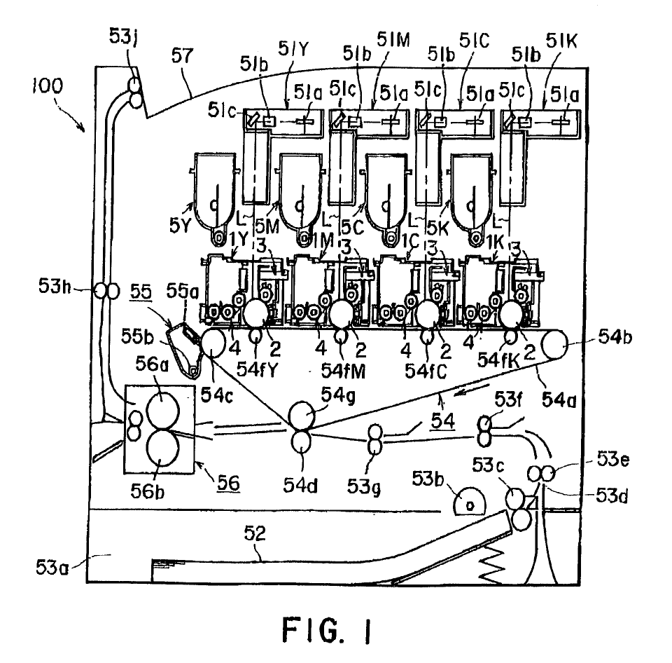

First, referring to FIG. 1, the general structure of an electrophotographic color image forming apparatus will be described. FIG. 1 is a drawing for depicting the general structure of a color laser beam printer, which is a form of an electrophotographic color image forming apparatus.

The image forming station of this color laser beam printer has four process cartridges 1Y, 1M, 1C, and 1K (yellow, magenta, cyan, and black colors), each of which has a photoconductive drum as an image bearing member. The image forming apparatus also has four exposing means 51Y, 51M, 51C, and 51K (laser beam based optical scanning systems), which are disposed above the process cartridges 1Y, 1M, 1C, and 1K, corresponding one for one to the preceding process cartridges identical in alphabetical referential code

Further, the image forming apparatus has a sheet feeding station for feeding a recording medium 52 into the main assembly of the image forming apparatus, an intermediary transfer belt 54a for transferring a toner image formed on the photoconductive drum 2, and a secondary transfer roller 54d for transferring a toner image on the intermediary transfer belt 54a onto the recording medium 52. The sheet feeding station, intermediary transfer belt 54a, and secondary transfer roller 54d are below the aforementioned image forming station.

Further, the color laser beam printer has a fixing means for fixing a toner image having means transferred onto the recording medium 52, and a discharging means for discharging the recording medium 52 from the apparatus main assembly and placing the recording media 52 in layers. The recording medium 52 is a sheet of paper, an OHP sheet, fabric, or the like.

The image forming apparatus in this embodiment is a cleaner-less apparatus. In other words, a cleaner dedicated for recovering and storing the transfer residual toner particles, that is, the toner particles which remain on the peripheral surface of the photoconductive drum 2, is not provided in a process cartridge, and the transfer residual toner particles are taken into the developing means.

Next, the structures of the various components of the above described image forming apparatus will be described in detail in the obvious orderly.

Sheet Feeding Station

The sheet feeding station is a station for delivering the recording medium 52 to the image forming station. Essentially, it comprises: a sheet feeder cassette 53a in which a plurality of recording media 52 are stored in layers; a sheet feeding roller 53b; a regarding roller pair 53c for preventing two or more recording media 52 from being delivered together; a sheet guide 53d; and a registration roller pair 53g.

The sheet feeding roller 53b is rotationally driven in synchronism with an image forming operation to feed the recording medium 52 one by one into the main assembly from the sheet feeding cassette 53a while separating the recording medium 52 at the top from the rest of the recording media 52 in the cassette 53a. Each recording medium 52 is prevented by the retard roller pair 53c, from being conveyed together with the other recording medium 52 or media 52. After being fed into the apparatus main assembly, the recording medium 52 is conveyed to the registration roller pair 53g by conveying roller pairs 53e and 53f while being guided by the sheet guide 53d.

During an image forming operation, the registration roller pair 53g carries out a predetermined sequence, which comprises two distinctive processes; a process in which the registration roller pair 53g is kept stationary to keep the recording medium 52 on standby, and a process in which the registration roller pair 53g is rotated to convey the recording medium 52 toward the intermediary transfer belt 54a. The registration roller pair 53g carries out this sequence so that a toner image and the recording medium 52 become aligned with each other for a transfer process, that is, the process which follows the toner image forming process.

Immediately after the conveyance of the recording medium 52, the registration roller pair 53g is not rotating. If the recording medium 52 is delivered askew to the registration roller pair 53g, it is straightened as it bumps into the nip of the registration roller pair 53g.

Process Cartridge

A process cartridge means a cartridge, which is removably mountable in the main assembly of an electrophotographic image forming apparatus, and in which a charging means, a developing means or a cleaning means, and an electrophotographic photoconductive drum, are integrally disposed. It also includes: a cartridge, which is removably mountable in the main assembly of an electrophotographic image forcing apparatus, and in which at least one means among a charging means, a developing means, and a cleaning means, and an electrophotographic photoconductive drum, are integrally disposed; and a cartridge, which is removably mountable in the main assembly of an electrophotographic image forming apparatus, and in which at least a developing means, and an electrophotographic photoconductive drums are integrally disposed. In this embodiment, the main assembly 100 of an image forming apparatus employs a cleaner-less system, which will be described later. Therefore, the process cartridge in this embodiment is such a cartridge in which a charging means, a developing means, and an electrophotographic photoconductive drum are integrally disposed, and which is removably mountable in the apparatus main assembly 100.

In each of the process cartridges 1Y, 1M, 1C,and 1K, a charging means and a developing means, and the photoconductive drum 2 are integrally disposed in such a manner that the charging means and developing means surround the peripheral surface of the photoconductive drum 2, that is, an image bearing member. This process cartridge 1 is enabled to be easily removed from the main assembly (which hereinafter will be referred to as apparatus main assembly 100) of an electrophotographic image forming apparatus by a user, so that it can be replaced as the service life of the photoconductive drum 2 expires. In this embodiment, whether or not the service life of the process cartridge 1 has expired is determined by counting the number of the rotations of the photoconductive drum 2 or a charging time period, and a user is informed of the expiration of the service life of the photoconductive drum 2 as the count exceeds a predetermined level.

The photoconductive drum 2 in this embodiment is an organic photoconductive member which is negatively charged. It comprises a base member, a photoconductive layer, and a charge injection layer. The base member is a cylindrical, hollow aluminum drum 2h, which is approximately 30 mm in diameter. The photoconductive layer is an ordinary photoconductive layer coated on the peripheral surface of the aluminum base drum 2h. The charge injection layer is the outermost layer. The photoconductive drum 2 is rotationally driven at a predetermined process speed, which is approximately 117 mm/sec in this embodiment.

The charge injection layer is a coated layer of dielectric resin (binder) in which electrically conductive microscopic particles, for example, SnOSUB-2/SUB, have been dispersed.

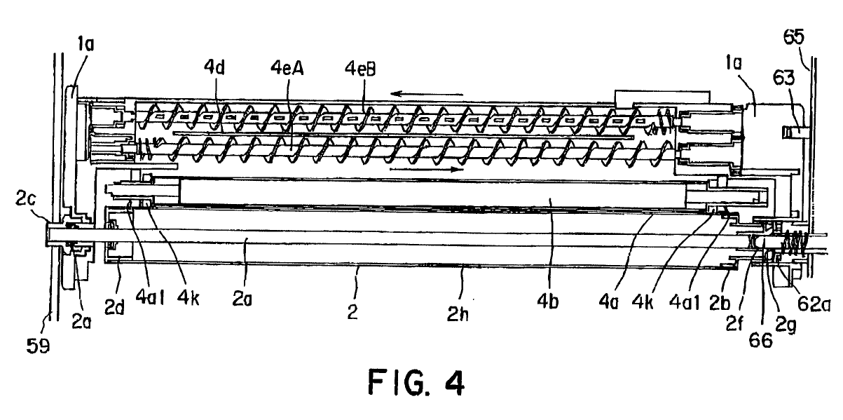

Referring to FIG. 4, the photoconductive drum 2 is provided with a drum flange 2b and a non-driven flange 2d. The drum flange 2b is fixed to the rear and (right-hand and in FIG. 4) of the base drum 2h of the photoconductive drum 2 in terms of the lengthwise direction of the photoconductive drum 2, and a non-driven flange 2d is fixed to the front end (left-hand end in FIG. 4). The photoconductive drum 2 also has a drum shaft 2a, which is put through the centers of the drum flange 2b and non-drive flange 2d. The drum shaft 2a and flange 2d are solidly fixed to each other. The base drum 2h, drum shaft 2a, drum flange 2b, and drum flange 2d, are rotated together. In other words, the photoconductive drum 2 is rotated about the axial line of the drum shaft 2a.

The front end of the drum shaft 2a is rotationally supported by a bearing 2, which is fixed to a bearing case 2c. The bearing case 2c is fixed to the frame 1a of the process cartridge 1.

Charging Means

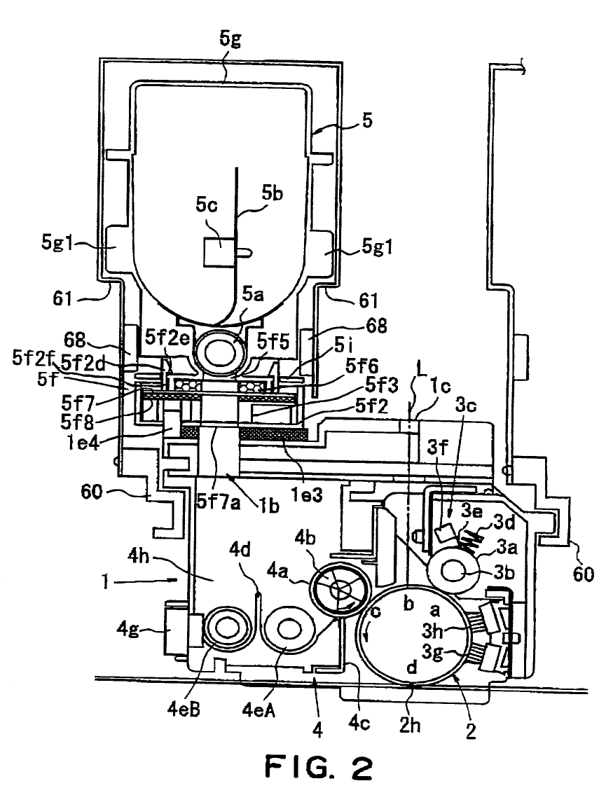

Referring to FIG. 2, the charging means in this embodiment is such a charging means that employs a contact charging method. It employs a charge roller 3a as a charging member. The charge roller 3a is rotationally supported by unshown bearings which support the lengthwise ends of the metallic core 3b of the charging roller 3a. It is kept under a predetermined amount of pressure generated by a pair of coil springs 3d in the direction of the photoconductive drum 2 so that the peripheral surface of the charge roller 3a is kept pressed upon the peripheral surface of the photoconductive drum 2. It rotates following the rotation of the photoconductive drum 2.

A referential code 3c designates a charge roller cleaning member, which comprises a supporting member 3f, and a flexible cleaning film 3c attached to the supporting member 3f. This cleaning film 3e is rectangular and is disposed in a manner to extend in parallel to the lengthwise direction of the charge roller 3a. It is fixed, by one of its long edges, to the supporting member 3f so that its surface adjacent to the other long edge, or the free long edge, forms a contact nip against the peripheral surface of the charge roller 3a. The supporting member 3f is enabled to reciprocally move a predetermined distance in the direction parallel to its lengthwise direction. As the supporting member 3f is driven by an unshown drawing means in a manner to reciprocally move a predetermined distance in its lengthwise direction, the peripheral surface of the charge roller 3a is rubbed by the cleaning film 3e. As a result, the foreign substances (microscopic toner particles, additives, and the like) which have adhered to the peripheral surface of the charge roller 3a are removed

The image forming apparatus in this embodiment employs a cleaner-less cleaning system. Next, this cleaner-less cleaning system will be described.

Cleaner-less Cleaning System

Referring to FIG. 2, the gist of the cleaner-less cleaning system of the image forming apparatus in this embodiment will be described. This cleaner-less cleaning system is such a cleaning system that removes the transfer residual toner particles on the photoconductive drum 2 by the developing means at the same time as the photoconductive drum 2 is charged by the developing means. More specifically, after the image transfer, the transfer residual toner particles on the photoconductive drum 2 are carried to a development station c, past the charge station a and an exposure station b, by the subsequent rotation of the photoconductive drum 2, and are removed by the developing means as the photoconductive drum 2 is charged by the developing means in the development station c.

Since the transfer residual toner particles on the peripheral surface of the photoconductive drum 2 pass through the exposure station b, the exposing process is carried out with the presence of the transfer residual toner particles an the peripheral surface of the photoconductive drum 2. But, the amount of the transfer residual toner particles on the peripheral surface of the photoconductive drum 2 is not large enough to significantly affect the exposing process. However, the transfer residual toner is a mixture of positively charged toner particles and negatively (reversely) charged toner particles. Further, some of the transfer residual toner particles are smaller in the amount of charge than the others. Thus, it is possible that as the reversely charged transfer residual toner particles and/or insufficiently charged transfer residual toner particles, on the peripheral surface of the photoconductive drum 2, pass through the charge station a, they adhere to the charge roller 3a. If the charge roller 3a is contaminated beyond a certain level by the adhesion of the transfer residual toner particles, the charge roller 3a fails to properly charge the photoconductive drum 2. Further, in order to improve the efficiency with which the transfer residual toner particles on the peripheral surface of the photoconductive drum 2 are removed by the developing apparatus at the same time as the photoconductive drum 2 is charged by the developing apparatus, it is necessary that the transfer residual toner particles on the photoconductive drum 2, which are carried to the development station c, are positive in polarity, and the amount of the charge of each transfer residual toner particle is proper for the developing apparatus to develop the electrostatic latent image on the photoconductive drum 2. The reversely charged toner particles, and the toner particles which are not proper in the amount of charge, cannot be removed or recovered from the photoconductive drum 2 by the developing apparatus, which results in the formation of a low quality image.

In recent years, user needs have diversified. For example, the user need for printing such an image as a photographic image that requires image forming apparatus to be continually operated at a high printing ratio has begun to increase. Thus, with the diversification of user needs, the above described problem has begun to widely manifest, since the continual operation of an image forming apparatus at a high printing ratio produces a large amount of transfer residual toner all at once.

Thus, in order to evenly disperse the transfer residual toner particles on the peripheral surface of the photoconductive drum 2, across the peripheral surface of the photoconductive drum 2, the image forming apparatus in this embodiment is provided with a transfer residual toner particle dispersing means 3g, which is disposed in the adjacencies of the peripheral surface of the photoconductive drum 2, on the downstream side of the transfer station d in terms of the rotational direction of the photoconductive drum 2. Further, the image forming apparatus is provided with a toner charge controlling means 3h for unifying in polarity the transfer residual toner (developer) particles. The toner charge controlling means 3h is disposed in the adjacencies of the peripheral surface of the photoconductive drum 2, on the downstream side of the transfer residual toner particle dispersing means 3g and on the upstream side of the charge station a, in terms of the rotational direction of the photoconductive drum 2. The toner charge controlling means 3h rectifies the polarities of the reversely charged transfer residual toner particles to the negative polarity, or the normal polarity.

With the provision of the transfer residual toner dispersing means 8g, the transfer residual toner particles, which have been dispersed in a certain pattern and are carried from the transfer station d to the toner charge controlling means 3h, are evenly dispersed across the peripheral surface of the photoconductive drum 2 even if the amount of the transfer residual toner particles is large. In other words, the transfer residual toner particles, which have been distributed in a certain pattern on the peripheral surface of the photoconductive drum 2, are evenly dispersed across the peripheral surface of the photoconductive drum 2, being therefore prevented from being concentrated to certain portions of the toner charge controlling means 3h, assuring that all the transfer residual toner particles are unified in polarity, being charged to the normal polarity. Therefore, the efficiency with which the transfer residual toner particles are prevented from adhering to the charge roller 3a is improved. Consequently, the formation of a ghost image, that is, the ghostly pattern in a completed image, for which the transfer residual toner particles are responsible, is prevented.

In this embodiment, the transfer residual toner particle dispersing means 3g and toner charge controlling means 3h are given a proper amount of electrical conductivity, and are in the form of a brush. They are disposed so that their actual brush portions remain in contact with the peripheral surface of the photoconductive drum 2.

These means are enabled to be moved (reciprocated) by unshown driving power source in the lengthwise direction of the photoconductive drum 2 so that the transfer residual toner particle dispersing means 3g and toner polarity controlling means 3h are prevented from remaining at the same positions relative to the peripheral surface of the photoconductive drum 2. Thus, even if the toner charge controlling means 3h is not uniform in electrical resistance and therefore, has portions with excessive charging capacity and portions with insufficient charging capacity, these portions do not remain at the same positions relative to the peripheral surface of the photoconductive drum 2. Consequently, the possibility that a microscopic amount of the transfer residual toner particles will be fused to certain portions of the peripheral surface of the photoconductive drum 2 by being overcharged, or remains adhered to certain portions of the peripheral surface of the charge roller 3a by being undercharged, is eliminated or reduced.

Exposing Means

In this embodiment, the photoconductive drum 2 is exposed with the use of a laser based exposing means. More specifically, image signals are sent to the exposing means from the image forming apparatus main assembly 100. As the signals are sent to the exposing means, a laser beam L modulated with the image signals is projected in a manner to uniformly scan the uniformly charged peripheral surface of the photoconductive drum 2. As a result, the uniformly charged peripheral surface of the photoconductive drum 2 is selectively exposed. Consequently, an electrostatic latent image in accordance with the image formation data is formed on the peripheral surface of the photoconductive drum 2.

Referring to FIG. 1, the laser based exposing means comprises a solid state laser element (unshown), a polygon mirror 51a, a focusing lens 51b, a reflection mirror 51c, and the like. The solid state laser element is turned on and off by a light emitting signal generating device (unshown) in response to the inputted image signals. The laser beam L emitted from the solid state laser element is converted by a collimator lens system (unshown) into a flux of virtually parallel light, is deflected in a manner to make a scanning movement, by the polygon mirror 51a which is being rotated at a high speed, and is focused in the form of a spot on the peripheral surface of the photoconductive drum 2 by way of the focusing lens 51b and deflection mirror 51c.

Since the photoconductive drum 2 is rotated while its peripheral surface is exposed to the scanning laser beam L, not only is the peripheral surface of the photoconductive drum 2 scanned by the laser beam L in the primary direction, or the moving direction of the laser beam L, but it also is scanned in the secondary direction, or the rotational direction of the photoconductive drum 2. As a result, the peripheral surface of the photoconductive drum 2 is exposed in a manner to reflect the sequential image signals. In other words, the uniformly charged peripheral surface of the photoconductive drum 2 is divided into light potential portions, that is, the portions, the surface potential of which has been reduced by the exposure to the laser beam L, and dark potential portions, that is, the portions, the surface potential of which has not been reduced by the laser beam L. Consequently, electrostatic latent image in accordance with the image formation data emerges due to the contrast between the light potential portions and dark potential portions.

Developing Apparatus

The developing apparatus 4 in this embodiment is a contact type developing apparatus which uses two component developer (two component magnetic brush type developing apparatus). Referring to FIG. 2, it comprises a development sleeve 4a as a developer bearing member, a magnetic roller 4b disposed in the hollow of the development sleeve 4a, and developer, that is, a mixture of carrier and toner, which is borne on the peripheral surface of the development sleeve 4a. This development sleeve 4a constitutes the developing means. The developing apparatus 4 is also provided with a regulating blade 4c, which is disposed a predetermined gap away from the peripheral surface of the development sleeve 4a so that as the development sleeve 4a is rotated in the direction of an arrow mark, a thin layer of the developer is formed on the peripheral surface of the development sleeve 4a. Incidentally, even though a two component magnetic brush type developing apparatus is employed as the developing apparatus 4 in this embodiment, the developing apparatus choice is not limited to this type of developing apparatus.

Referring to FIG. 4, the development sleeve 4a has a pair of journal portions 4a1, which are located at the lengthwise ends of the development sleeve 4a one for one. The smaller diameter portion of each journal portion 4a1 is fitted with a rotational spacer ring 4k in the form of a hollow roller so that a predetermined gap is maintained between the peripheral surfaces of the development sleeve 4a and photoconductive drum 2 to allow the layer of developer found on the peripheral surface of the development sleeve 4a to make contact with the peripheral surface of the photoconductive drum 2 to develop the latent image on the peripheral surface of the photoconductive drum 2. Referring to FIG. 2, the development sleeve 4a is rotationally driven at a predetermined peripheral velocity in the counterclockwise direction indicated by an arrow mark so that the moving direction of the peripheral surface of the development sleeve 4a in the development station becomes counter to the moving direction of the peripheral surface of the photoconductive drum 2 in the development station.

The toner employed in this embodiment is 6 Jm in average particle diameter, and is negatively charged. The magnetic carrier employed in this embodiment is 35 Jm in average particle diameter and is 205 emu/cSUP3/SUP in saturation magnetization The toner and carrier are mixed at a weight ratio of 6:94 to be used as the developer. Developer choice does not need to be limited to a mixture of toner and magnetic carrier. For example, magnetic toner may be employed.

Referring to FIG. 2, a developer holding portion 4h, in which the developer is circulated, is divided by a partitioning wall 4d into a two chambers. The partitioning wall 4d extends in the lengthwise direction of the process cartridge 1 from one end of the developer holding portion 4h to the other except for the immediate adjacencies of the end walls of the developer holding portion 46. The developer holding portion 4h is provided with a pair of stirring screws 4eA and 4eB, which are disposed in a manner to sandwich the partitioning wall 4d.

Referring to FIG. 4, as toner is supplied into the developer holding portion 4h from a toner supply container 5, it falls into the rear side (right side in FIG. 4) of stirring screws 4eB, and is sent toward the front side (left side in FIG. 4) while being stirred. As the toner reaches the front end of the toner holding portion 4h, it moves into the other side of the partition wall 4d, past the gap between the front and of the partition wall 4d and the front wall of the developer holding portion 4h. Then, it is sent by the stirring screw 4eA to the rear end (right side in FIG. 4). As it reaches the rear end of the developer holding portion 4h, it moves into the side into which it fell from the toner supply container 5, and is sent again by the stirring screw 4eB toward the front end to be recirculated.

At this time, the development process for visualizing an electrostatic latent image formed on the photoconductive drum 2, with the use of the developing apparatus 4 which employs a two component magnetic brush based developing method, and the developer circulating system, will be described with reference to FIG. 2. As the development sleeve 4a is rotated, the developer within the developer holding portion 4h is picked up in a layer by the pickup pole of the magnetic roller 4b onto the peripheral surface of the development sleeve 4a, and is conveyed toward the development station.

As the layer of developer on the peripheral surface of the development sleeve 4a is conveyed toward the development station, its is regulated in thickness by the regulating blade 4c disposed in the radius direction of the development sleeve 4a. As a result, a thin layer of developer is formed on the peripheral surface of the development sleeve 4a. As this thin layer of developer is conveyed to a position in the development station, which corresponds to the development pole, the developer is made to crest like a wave by the magnetic force. The electrostatic latent image on the peripheral surface of the photoconductive drum 2 is developed by the toner within the crested portion of the thin layer of developer into a toner image. It should be noted here that in this embodiment, the electrostatic latent image is reversely developed.

As the development sleeve 4a is further rotated, the thin layer of developer on the peripheral surface of the development sleeve 4a passes the development station and enters the developer holding portion 4h, in which it is repelled by the repellent magnetic field of the conveyance pole, from the peripheral surface of the development sleeve 4a, and falls back into the developer holding portion 4h.

To the development sleeve 4a, DC and AC voltages are applied from unshown electrical power sources. More specifically, in this embodiment, a DC voltage of −500 V, and AC voltage having a frequency of 2,000 Hz and a peak-to-peak voltage of 1,500 V, are applied to selectively develop the peripheral surface of the photoconductive drum 2; only the exposed portions of the peripheral surface of the photoconductive drum 2 are developed.

Generally speaking, in a two component magnetic brush based developing method, application of AC voltage improves the development efficiency, and therefore, improves image quality. However, it also brings forth such an adverse possibility that a foggy image will be produced. Thus, normally, difference in potential level is provided between the DC voltage applied to the development sleeve 4a and the electrical charge of the peripheral surface of the photoconductive drum 2 to prevent the formation of a foggy image. More concretely, the potential level of the bias voltage applied to the development sleeve 4a is set so that it falls between the surface potential levels of the exposed and unexposed portions of the photoconductive drum 2.

As the toner is consumed by development, the toner density of the developer reduces. Referring to FIG. 2, in this embodiment, a sensor 4g for detecting the toner density is disposed close to the peripheral surface of the stirring screw 4eB. As it is detected by the sensor 4g that the toner density of the developer has dropped below a predetermined level, a command for supplying toner into the developer holding portion 4h of the developing apparatus from the toner supply container 5 is issued. The toner density of the developer is kept at a predetermined level by this toner supplying process.

Toner Supply Container

Toner supply containers 5Y, 5N, 5C,and 5K are disposed in parallel to each other, above the process cartridges 1Y, 1M, 1C, and 1K, one for one. They are mounted from the front side of the image forming apparatus main assembly 100.

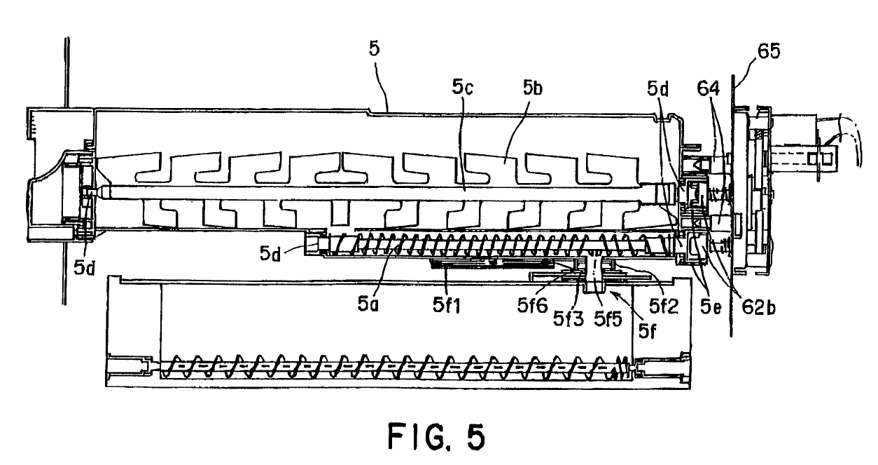

Referring to FIG. 2, each toner supply container 5 comprises a shell 5g as a toner holding portion (developer holding portion), a stirring shaft 5c, a stirring plate 5b, and a screw 5a. Toner or a mixture of toner and magnetic carrier is stored in the shell 5g. The stirring plate 5b is fixed to the stirring shaft 5c. The stirring shaft 5c, stirring plate 5b and screw 5a are disposed within the shell 5g. The bottom wall of the toner supply container 5 is provided with a toner outlet hole 5f through which toner is discharged. Referring to FIG. 5, the screw 5a and stirring shaft 5c are rotationally supported by a pair of bearings 5d, by their lengthwise ends. The rearmost ends of the screw 5a and stirring shaft 5c are fitted with a driving coupling 5e (female type). The driving coupling 5e (female type) is rotationally driven as it receives driving force from the driving coupling 62b (male type) on the apparatus main assembly 100 side. The peripheral portion of the screw 5a in terms of the radius direction of the screw 5a is in the form of a spiral rib, and has right and left sections, with respect to the axial line of the toner outlet hole 5f, which are opposite to each other in twist direction. The screw 5a is rotated in a predetermined direction by the rotation of the driving coupling 62b (male type). As the screw 5a rotates, toner is conveyed toward the toner outlet portion 5f, and is allowed to free fall through the toner outlet hole 5f5 of the toner outlet portion 5f to supply the process cartridge 1 with toner.

The peripheral edge of the stirring plate 5b in terms of the rotational radius direction is angled relative to the internal surface of the wall of the shell 5g, so that it makes contact with, and slides on, the internal surface of the wall of the shell 5g at an angle. More specifically, as the peripheral portion of the stirring plate 5b comes into contact with the wall of the shell 5g, it becomes spirally twisted. Therefore, as the stirring plate 5b is rotated, the peripheral portion of the stirring plate 5b contacts the toner at an angle, generating such force that moves the toner in the axial direction of the stirring shaft 5c. As a result, the toner is conveyed in the lengthwise direction of the process cartridge 1.

Incidentally, the toner supply container 5 in this embodiment is capable of supplying toner to not only a process cartridge which employs a two component developing method, but also a process cartridge which employs a single component developing method. It also is capable of supplying a development cartridge with toner. The choice of the powdery substance which is to be held in the toner supply container does not need to be limited to toner. Obviously, it may be so-called developer, that is, a mixture of toner and magnetic carrier.

Transferring Means

Referring to FIG. 1, an intermediary transfer unit 54, which is a transferring means, is a unit for transferring a toner image.

The intermediary transfer unit 54 is provided with an intermediary transfer belt 54a, which runs in the direction of an arrow mark. More specifically, the intermediary transfer belt 54a runs in the clockwise direction indicated by the arrow mark at a velocity approximately the same as the peripheral velocity of the photoconductive drum 2. This intermediary transfer belt 54a is an endless belt with a circumferential length of approximately 940 mm, and is suspended around three rollers: a driver roller 54b, a secondary transfer counter roller 54g, and a follower roller 54c.

Within the loop of intermediary transfer belt 54a, transfer charge rollers 54fY, 54fM, 54fC, and 54fK are rotationally disposed, each being kept pressured upon the inward surface of the intermediary transfer belt 54a, at a position correspondent to the photoconductive drum 2 on the outward side of the intermediary transfer belt 54a, in the radius direction of the photoconductive drum 2 of the corresponding process cartridge.

The transfer charge rollers 54fY, 54fM, 54fC, and 54fX receive electrical power from an unshown high voltage power source, and charge the intermediary transfer belt 54a to the polarity opposite to the toner polarity, from the inward side of the intermediary transfer belt loop, to sequentially transfer (primary transfer) the toner images on the photoconductive drums 2 onto the outward surface of the intermediary transfer belt 54a.

In the secondary transfer station, the secondary transfer roller 54d and secondary transfer counter roller 54g are disposed on the inward and outward sides of the intermediary transfer belt loop. When carrying out the second transfer process, the two rollers are pressed against each other in a manner to pinch the intermediary transfer belt 54a between them. The secondary transfer roller 54d is rotational, and also is movable in the vertical direction in FIG. 1. In order to prevent the secondary transfer roller 54d from disturbing the toner images on the intermediary transfer belt 54a, the secondary transfer roller 54d is kept separated from the intermediary transfer belt 54a until a multicolor image is completed, that is, until all the monochromatic toner images are transferred in layers onto the intermediary transfer belt 54a.

The intermediary transfer belt 54a and secondary transfer roller 54d are driven independently from each other. As the recording medium 52 enters the secondary transfer station, a predetermined bias is applied to the secondary transfer roller 54d. As a result, the multicolor toner image on the intermediary transfer belt 54a is transferred (secondary transfer) onto the recording medium 52.

During the above described secondary transfer process, the recording medium 52 is conveyed leftward in FIG. 1 at a predetermined velocity, while remaining pinched by the intermediary transfer belt 54a and secondary transfer roller 54d, to a fixing device 56 in which the next process is carried out.

At the most downstream end of the range in which the transfer process is carried out, a cleaning unit 55 is located, being enabled to be placed in contact with, or separated from, a predetermined point of the outward surface of the intermediary transfer belt 54a to remove the secondary transfer residual toner particles, or the toner particles remaining on the intermediary transfer belt 54a after the secondary transfer.

Referring to FIG. 1, a cleaning blade 55a for removing the second transfer residual toner particles is placed within a cleaning unit 55, which is rendered pivotal about an unshown pivot. The cleaning blade 55a is kept pressed upon the intermediate transfer belt 54a, being tilted against the moving direction of the intermediate transfer belt 54a. The secondary transfer residual toner particles are taken into the cleaning unit 55 and are conveyed by a conveying screw 55b to a container (unshown) for the secondary transfer residual toner particles, to be stored therein.

As for the material for the intermediary transfer belt 54a, polyimide resin may be used. The material selection is not limited to polyimide. For example, plastics such as polycarbonate resin, polyethylene-terephthalate resin, polyfluorovinylidene resin, polynaphthalate resin, polyether-ether-ketone resin, polyether-sulfone resin, or polyurethane resin, as well as fluorinated rubber or siliconized rubber, can also be used with preferable results, in addition to the polyimide resin.

Fixing Station

As described above, after being formed on the photoconductive drum 2 by the developing means, the toner image is transferred onto the recording medium 52 by way of the intermediary transfer belt 54a, and is thermally fixed to the recording medium 52 by the fixing device 56.

Referring to FIG. 1, the fixing device 56 has a fixing roller for applying heat to the recording medium 52, and a pressing roller 56b for pressing the recording medium 52 upon the fixing roller 56a. Both rollers are hollow, and contain a heater (unshown). They convey together the recording medium 52 as they are rotationally driven.

More specifically, heat and pressure are applied to the toner image and recording medium 52 as the recording medium 52 on which the toner image is held is conveyed by the fixing roller 56a and pressing roller 56b. As a result, the toner image is fixed to the recording medium 52. After the fixation of the toner image, the recording medium 52 is discharged by a discharge roller pair 53h and a discharge roller pair 53j from the apparatus main assembly 100, and is accumulated in a tray 57 located at the top of the apparatus main assembly 100.

Mounting of Process Cartridge and Toner Supply Container

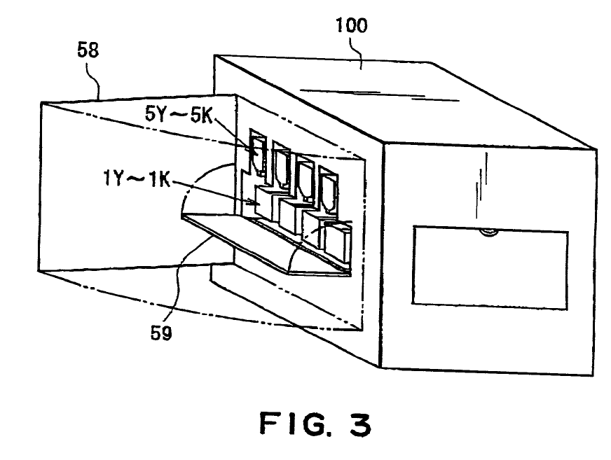

Next, referring to FIGS. 2-5, the steps through which the process cartridge 1 and toner supply container 5 are mounted into the apparatus main assembly 100 will be described. FIG. 3 is a rough, external perspective view of the image forming apparatus main assembly 100. As show in FIG. 3, the image forming apparatus main assembly 100 is provided with a front door 58, which is located on the front side of the apparatus main assembly 100, and can be opened or closed by a user. As the front door 58 is pulled frontward, an entrance through which the process cartridges 1Y-1X, and toner supply containers 5Y-5K are inserted into the apparatus main assembly 100 is exposed.

The entrance through which each process cartridge 1 is inserted is provided with an aligning plate 59, which is rotationally supported. The process cartridge 1 is inserted or pulled out after this aligning plate is opened. Referring to FIG. 2, within the image forming apparatus main assembly 100, guide rails 60 for guiding the process cartridge 1 when mounting or dismounting the process cartridge 1, and guide rails 61 for guiding the toner supply container 5 when mounting or dismounting the toner supply container 5, are disposed.

The direction in which the process cartridge 1 or toner supply container 5 are mounted into the image forming apparatus main assembly 100 is parallel to the axial line of the photoconductive drum 2.

Also, the direction in which the guide rails 60 and 61 are extended is parallel to the axial line of the photoconductive drum 2. When mounting the process cartridge 1 or toner supply container 5, it is said into the apparatus main assembly 100, on the guide rails 60 or 61, respectively, for the front side of the apparatus main assembly 100.

Referring to FIG. 4, as the process cartridge 1 is inserted to the deepest end of the cartridge mounting space, the aligning shaft 66 of the apparatus main assembly 100 is inserted into the center hole 2f of the drum flange 2b. As a result, the position of the rotational axis of the deepest and (rear end) of the photoconductive drum 2 becomes fixed relative to the apparatus main assembly 100 at the same time, the driving force transmitting portion 2g of the drum flange 2b is connected with the driving coupling 62a (female type) of the apparatus main assembly 100, enabling the photoconductive drum 2 to be rotationally driven. The driving force transmitting portion 2g employed in this embodiment is in the form of a twisted triangular pillar. Thus, as it is rotated, not only does it transmit the driving force from the apparatus main assembly 100 side to the photoconductive drum 2, but also it generates such force that pulls the photoconductive drum 2 rearward of the apparatus main assembly 100.

Referring to FIG. 4, the rear plate 65 is provided with a supporting pin 63 for positioning the process cartridge 1; the position of the frame 1a of the process cartridge 1 relative to the apparatus main assembly 100 is fixed as the supporting pin 63 is inserted into the frame 1a of the process cartridge 1.

Also referring to FIG. 4, the apparatus main assembly 100 is provided with a rotatable aligning plate 59, which is located on the front side (left side in FIG. 4). Into the hole of this aligning plate 59, the bearing case 2c of the process cartridge 1 is inserted, so that the process cartridge 1 is supported by the apparatus main assembly 100 while being accurately positioned relative to the apparatus main assembly 100. Through the above described insertion sequence, the photoconductive drum 2 and process cartridge 1 are accurately positioned relative to the apparatus main assembly 100.

Referring to FIG. 5, as the toner supply container 5 is inserted to the deepest end of the toner supply container mounting space in the same manner as the process cartridge 1 is inserted to the deepest end of the process cartridge mounting space, the position of the toner supply container 5 is fixed relative to the apparatus main assembly 100 by a supporting pin 64 which projects from the rear plate 65. At the same time, the driving coupling 5e (female type) become connected with the driving coupling 62b (male type), enabling the screws 5a and stirring shaft 5c to be rotationally driven.

On the other had, in order to pull the process cartridge 1 or toner supply container 5 out of the apparatus main assembly 100, the above described mounting steps have only to be carried out in the reverse order. In this embodiment, the process cartridges 1 and toner supply containers 5 are filed to be mounted into, or dismounted from, the apparatus main assembly 100 in any order. In other words, the process cartridge 1 can be mounted into the apparatus main assembly 100 either before or after the toner supply container 5 is mounted into the apparatus main assembly 100. Further, the process cartridge 1 can be pulled out of the apparatus main assembly 100 either before or after the toner supply container 5 is pulled out of the apparatus main assembly 100.

EMBODIMENTS

Referring to FIGS. 1-24, the embodiments of the present invention will be described.

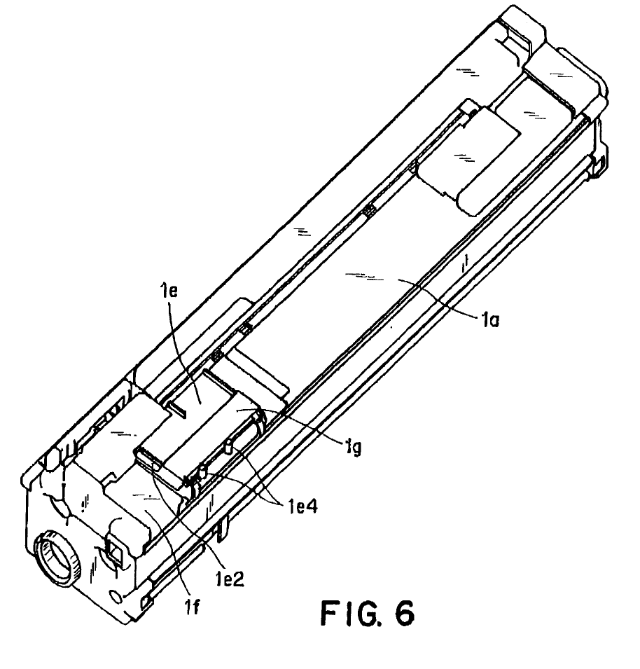

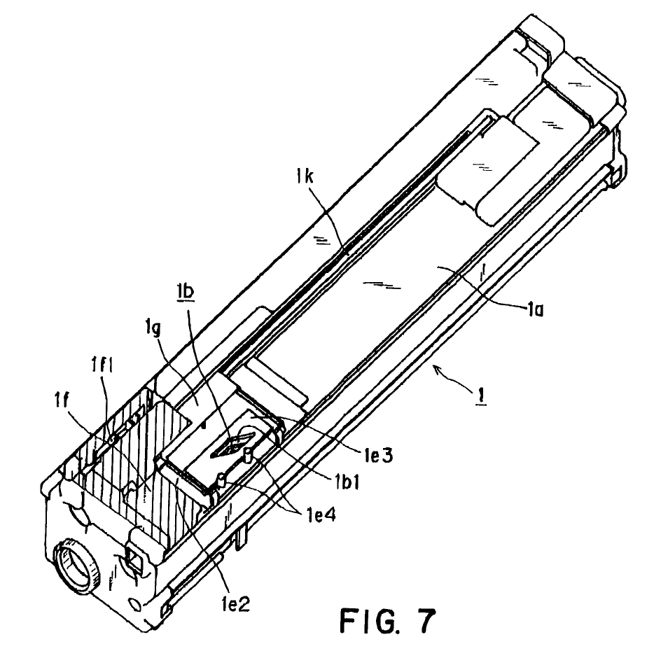

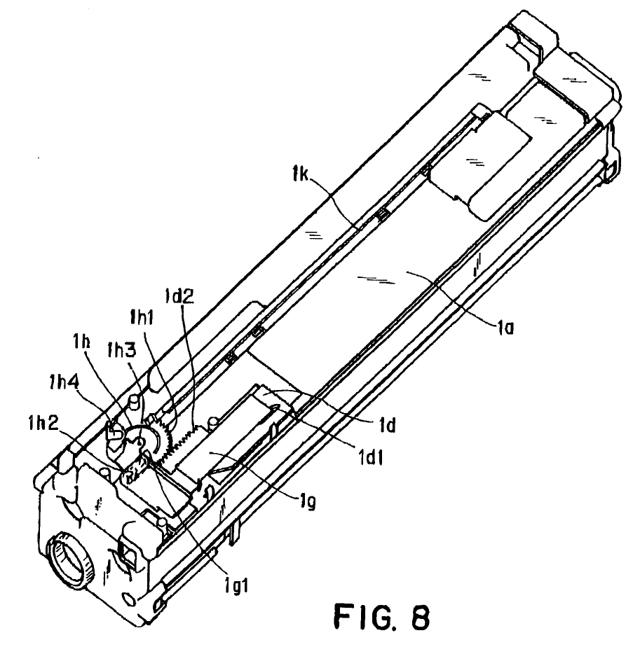

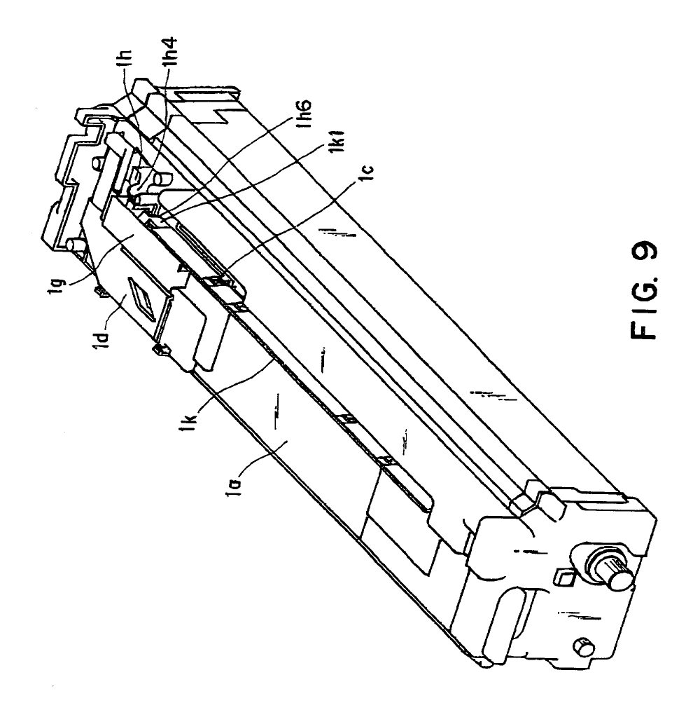

FIGS. 6, 7 and 8 are perspective views of a process cartridge as seen from a rear side thereof, wherein FIG. 6 is a view in which and toner inlet hole shutter 1d (first opening and closing member) and a toner inlet hole cover (second opening and closing member) 1g are closed, and FIG. 7 is a view in which the shutter 1d and cover 1b are opted. FIG. 8 is a view in which a cover above the shutter opening and closing mechanism is removed to expose the inside. FIG. 9 is a perspective view of a process cartridge 1 as seen from a front side, in which the shutter 1d and the cover 1g are open, and the cover of the shutter opening and closing mechanism is removed to expose the inside.

Connecting portion of process cartridge

FIG. 13 is an enlargement of a connecting portion between the process cartridge 1 and toner supply container 5, in which the shutter 1d mounted to the upper portion is removed. As shown in FIG. 13, an upper surface of a frame 1a constituting a part of a process cartridge 1 is provided with an inlet hole 1b for connection with a opening 5f of a toner supply container 5, and in the inlet hole 1b, there is provided an inlet hole 1b1 which is a through-hole for permitting toner supply from the toner supply container 5. In this embodiment, the inlet hole 1b is disposed at the drive transmission side of the photosensitive drum 2, that is, at the rear side in the inserting direction of the process cartridge 1.

A seal member 1j is bonded on the upper surface of the frame 1a around the inlet hole 1b1, and the seal member 1j is provided with an opening of a substantially the same as the inlet hole 1b1. The material of the seal member 1j is preferably elastic and preferably has a low surface sliding resistance, and in this embodiment, the comprises an urethane foam and a sliding sheet bonded on the upper surface thereof.

On the upper surface of the frame 1a, two guide grooves 1a1 are formed on a line. The guide grooves 1a1 are linear in parallel with the longitudinal direction.

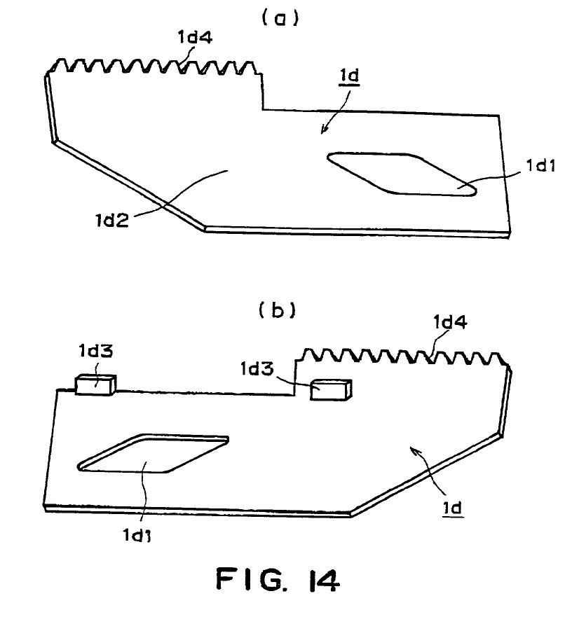

Referring to FIG. 14, the description will be made as to an inlet hole shutter 1d mounted on the seal member 1j. FIG. 14 is a view of an inlet hole shutter 1d as seen from a front side (a), and a view of the inlet hole shutter 1d as seen from the back side. As shown in (a) of FIG. 14, the upper left part of the inlet hole shutter 1d is provided with a rack 1d4 for meshing engagement with a circular gear for conversion of a rotational motion to a linear motion. The inlet hole shutter 1d has an opening 1d1 having substantially the same configuration as the hole of the inlet hole 1b1, and the left side of the opening 1d1 constitutes a shielding wall 1d2.

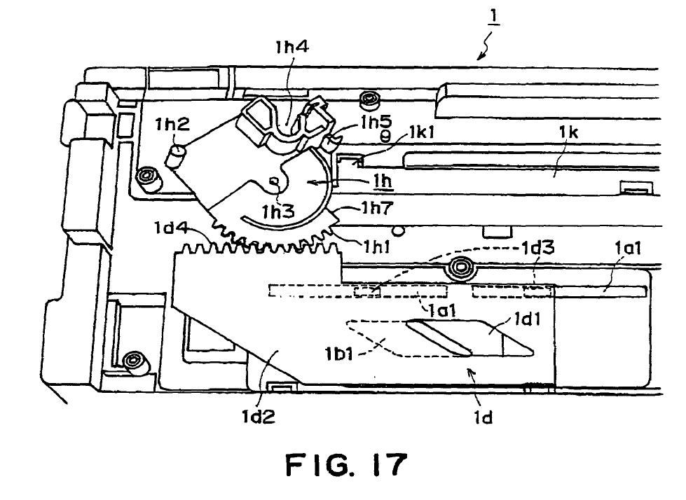

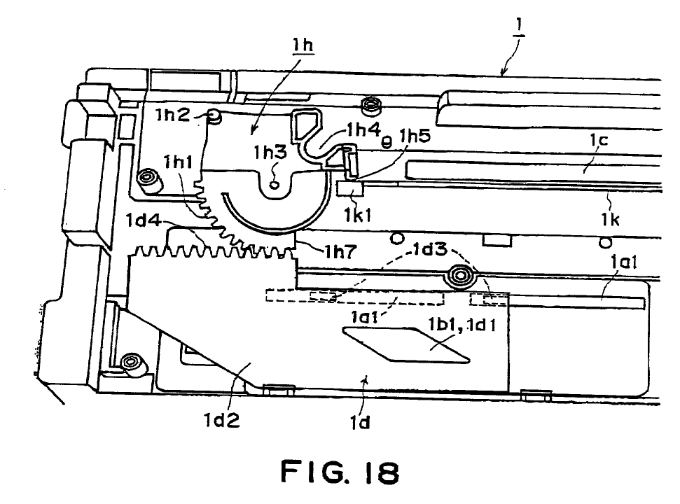

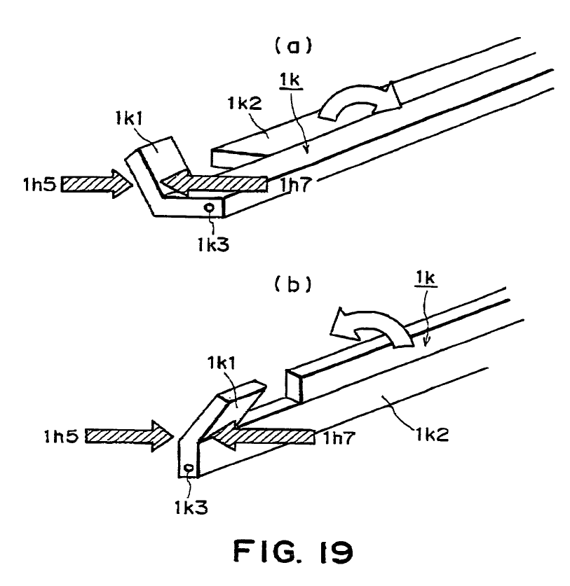

As shown in FIG. 14, (b), the back side of the inlet hole shutter 1d is provided with two guiding ribs 1d3. When the inlet hole shutter 1d is placed on a seal member 1j as shown in FIG. 13, the guiding rib 1d3 is slidably engaged with a guide groove 1a1 so that inlet hole shutter 1d is guided along a guide groove 1a1 for linear movement in the longitudinal direction. When the inlet hole shutter 1d takes a righthand side position in FIG. 13, the inlet hole 1b1 is closed by a shielding wall 1d2 (FIG. 16), and when the inlet hole shutter 1d takes a left side in FIG. 13, the inlet hole 1b1 and the opening 1d1 are overlapped to permit supply of the toner. The rack 1d4 and a line connecting the two guiding ribs 1d3 are parallel with each other. FIG. 17 shows a state between the state shown in FIG. 16 and a state shown in the FIG. 18.

As shown in FIG. 18, the top surface of the frame 1a is provided with an exposure opening 1c for passing of a laser beam L. A laser shutter (third opening and closing member) 1k is rotatably mounted to the frame 1a to prevent the photosensitive drum 2 from being exposed to external light when the process cartridge 1 is taken out of the main assembly 100 of the apparatus. The laser shutter 1k operates in interrelation with a motion of the shutter opening and closing cam 1h to open ad close the shutter. Here, the laser shutter 1k is rotatable mounted on the frame 1a at a rotation center 1k3 (FIG. 19) in the longitudinal direction.

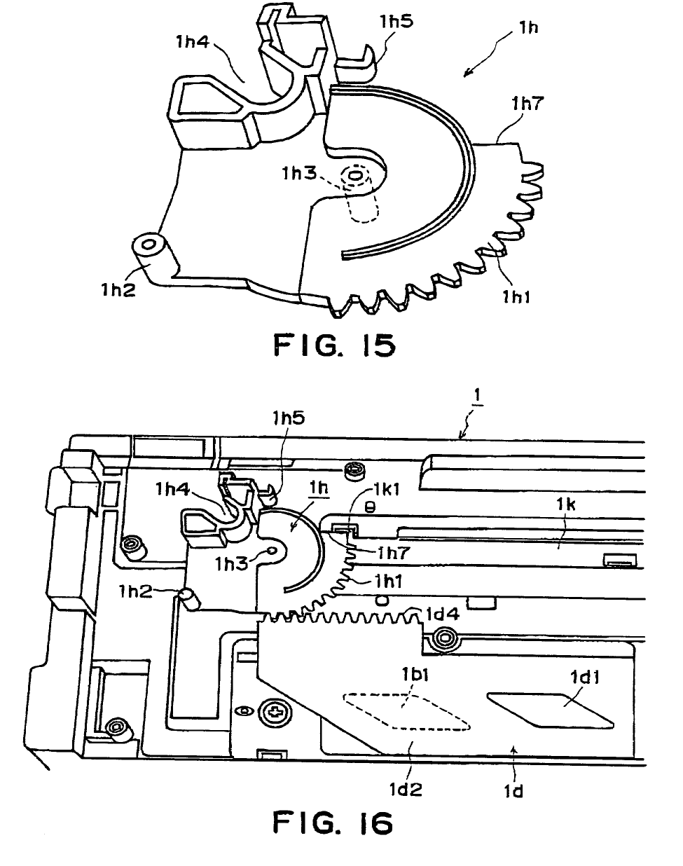

Referring to FIG. 15, the description will be made as to a shutter opening and closing cam 1h. The shutter opening and closing cam 1h is provided with a gear portion 1h1 over a ¼ circumference, and one end of the portion 1h1 constitutes an end surface 17. The shutter opening and closing cam 1h is provided with a pin 1h2 extending substantially vertically upward. The backside is provided with a center pin 1h3, which is rotatably supported in a hole formed in the frame 1a such that shutter opening and closing cam 1h is rotatable about the center pin 1h3.

There is formed a cam portion 1h4 at a position generally opposite from the gear portion 1h1 with respect to the center pin 1h3. A cam portion 1h4 each in the form of a slit or the like extended toward the center pin 1h3 and is engageable with a pin 67 provided in the main assembly 100 of the apparatus which will be described hereinafter. At a side of the cam portion 1h4, there is provided an engaging portion 1h5 which cooperates with the abutment end surface 1h7 to open and close the laser shutter 1k.

Referring to FIGS. 16-19, the description will be made as to an operation relation among the shutter opening and closing cam 1h, the inlet hole shutter 1d and the laser shutter 1k. FIG. 16 to FIG. 18 show the opening operation of the inlet hole shutter 1d and the laser shutter 1k. In FIG. 16, the inlet hole shutter 1d takes the right side position in which the inlet hole 1b1 and the opening 1d1 are not aligned, and therefore, the inlet hole 1b1 is closed by the shielding wall 1d2. At this time, the abutment end 1h7 of the shutter opening and closing cam 1h is abutted to the opening and closing portion 1k1 of the laser shutter 1k, so that laser shutter 1k is closed. The gear portion 1h1 of the shutter opening and closing cam 1h and rack 1d4 of the inlet hole shutter 1d are in meshing engagement with each other.

As shown in FIGS. 17, when the shutter opening and closing cam 1h is rotated above the center pin 1h3, the rotating operation of the shutter opening and closing cam 1h is converted to a linear motion of the inlet hole shutter 1d due to the engagement of the rack 1d4 with the gear portion 1h1, so that inlet hole shutter 1d moves to the left in the Figure. At this time, the guiding rib 1d3 provided on the back side of the inlet hole shutter 1d is engaged with the guide groove 1a1 and slides along the guide, so that inlet hole shutter 1d movements lead nearly toward left in the longitudinal direction along the guide groove 1a1.

As shown in FIG. 18, when the shutter opening and closing cam 1h further rotates, the inlet hole shutter 1d moves to the left side, and stops at such a position that opening 1d1 is overlapped with the inlet hole 1b1. In addition, an engaging portion 1h5 of the shutter opening and closing cam 1h is abutted to the opening and closing portion 1k1 to raise it, thus opening the laser shutter 1k. In this manner, the exposure opening 1c is opened.

Conversely, when the shutter opening and closing cam 1h is rotated in the counterclockwise direction about the center pin 1h3, the inlet hole shutter 1d moves to the right side to close the inlet hole 1b1 with the shielding wall 1d2. As shown in FIG. 16, the abutment end surface 1h7 of the shutter opening and closing cam 1h is abutted to the laser shutter 1k, by which the laser shutter 1k is tilted to close.

Referring to FIG. 19, the description will be made as to an opening and closing operation of the laser shutter 1k by the shutter opening and closing cam 1h. FIG. 19 shows a state in which the laser shutter 1k is closed (a), and shows a state in which the laser shutter 1k is open (b). In the state shown in (a) of FIG. 19, the upper surface of the opening and closing portion 1k1 inclined by approx. 45° retroactive to the shutter surface 1k2 of the laser shutter 1k receives a force from the right side in the Figure by the abutment end surface 1h7 of the shutter opening and closing cam 1h, and the laser shutter 1k in the close state (sealing state) . When the shutter opening and closing cam 1h rotates, the engaging portion 1h5 of the shutter opening and closing cam 1h is abutted to the bottom surface of the opening and closing portion 1k1 as shown in (b) of FIG. 19, so that force is applied from the left side in the Figure to raise the opening and closing portion 1k1, thus erecting the shutter surface 1k2, thus opening the laser shutter 1k (opening state).

Conversely when the laser shutter 1k is closed, the force is applied by the abutment and surface 1h7 of the shutter opening and closing cam 1h from the righthand side in the FIG. 19. (b) (opening state). As shown in (a) of the FIG. 19, the shutter surface 1k2 is tilted to close the laser shutter 1k (sealing state).

When the laser shutter 1k is in the closing position, the end surface 1h7 of the cam 1h is contacted to the opening and closing portion 1k1, and therefore, the laser shutter 1k is prohibited from opening unless the cam 1h is rotated.

As described in the foregoing, the inlet hole shutter 1d and the laser shutter 1k are opened and closed by the rotating operation of the shutter opening and closing cam 1h.

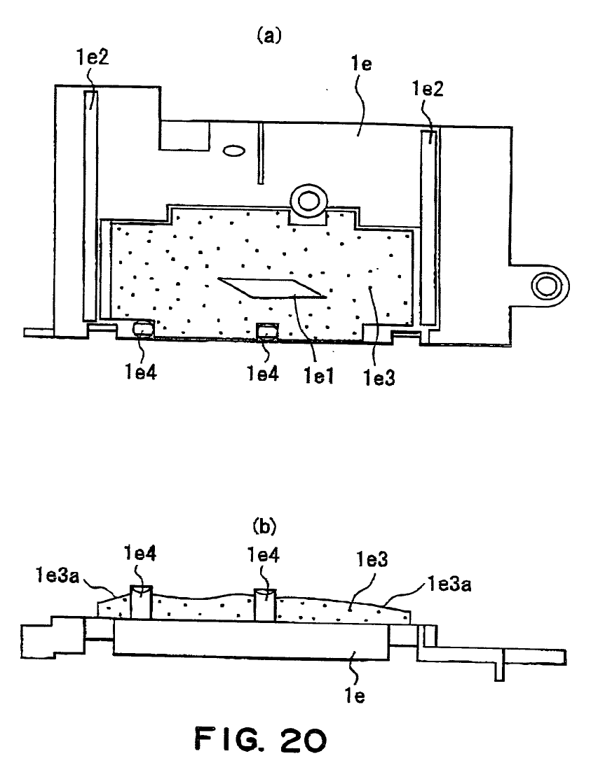

Referring to FIG. 20, the description will be made as to a first pushing member 1e for urging the inlet hole shutter 1d from the top to prevent disengagement from the frame 1a. FIG. 20 is a top plan view of the first pushing member 1e as seen from the top side (a), and a side view of the first pushing member 1e (b) .

As shown in (a) of FIG. 20, the first pushing member 1e is provided with an opening 1e1 having substantially the same configuration corresponding to the toner inlet hole 1b1 (supply portion), and an elastic seal member 1e3 is bonded around the opening 1e1. At a lower positioned in the Figure, there are provided two projected guide plans 1e4 for rotating an outlet hole shutter 5f3 provided in the toner supply container 5 which will be described hereinafter. The inlet hole 1b1 is a through-hole, and a seal member 1e3 is provided so as to cover the circumference.

The seal member 1e3, when it is contacted to the toner supply container 5, functions to maintain the sealing property. It preferably has an elasticity, and exhibits good toner wiping or scraping property with low sliding resistance. The seal member 1e3 may be a Teflon felt, a Teflon pile, an urethane foam or a material provided by electrostatic flock material or the like.

As shown in FIG. 20, (b), when the seal member 1e3 is seen in the direction of the thickness, it is not a rectangular shape, but left and right portions are lowered to provide left and right inclined surfaces 1e3a. By the provision of the inclined surfaces 1e3a with the seal member 1e3, the toner supply container 5 can be smoothly contacted.

The first pushing member 1e is placed over the shutter opening and closing cam 1h inlet hole shutter 1d shown in FIG. 16, by which the shutter opening and closing cam 1h and the inlet hole shutter 1d are prevented from disengaging from the frame 1a. At this time, the opening 1e1 formed in the first pushing member 1e is in alignment with the inlet hole 1b1. As shown in (a) of FIG. 20, the first pushing member 1e is provided with two guide grooves 1e2 at both of the sides of the seal meets 1e3. The guide groove 1e2 is in the form of a groove which is linearly extended along the short side, and the guide grooves 1e2 are parallel with each other. Along the guide grooves 1e2, an inlet hole cover 1g which will be described hereinafter moves in the direction perpendicular to the longitudinal direction.

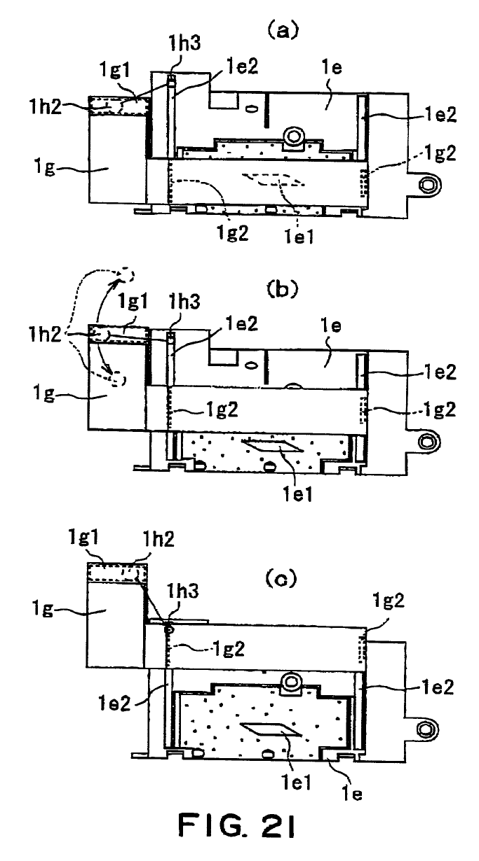

On the first pushing member 1e, there is provided an inlet hole cover 1g as shown in FIG. 21. The inlet hole cover 1g is L-shaped, and the backside thereof is provided with guiding ribs 1g2 which are projected for slidable engagement with the two guide grooves 1e2. The inlet hole cover 1g is guided by the guide groove 1e2 along the short side to slide until it closes or opens the opening 1e1 formed in the first pushing member 1e.

In other words, the inlet hole shutter 1d and the inlet hole cover 1g move into directions which are perpendicular to each other.

In this embodiment, the inlet hole cover 1g is moved in a direction perpendicular to the longitudinal direction, but the moving direction of the inlet hole cover 1g is not limited to this direction, but may be any direction which is different from the mounting-and-demounting of the process cartridge 1 relative to the main assembly 100 of the apparatus.

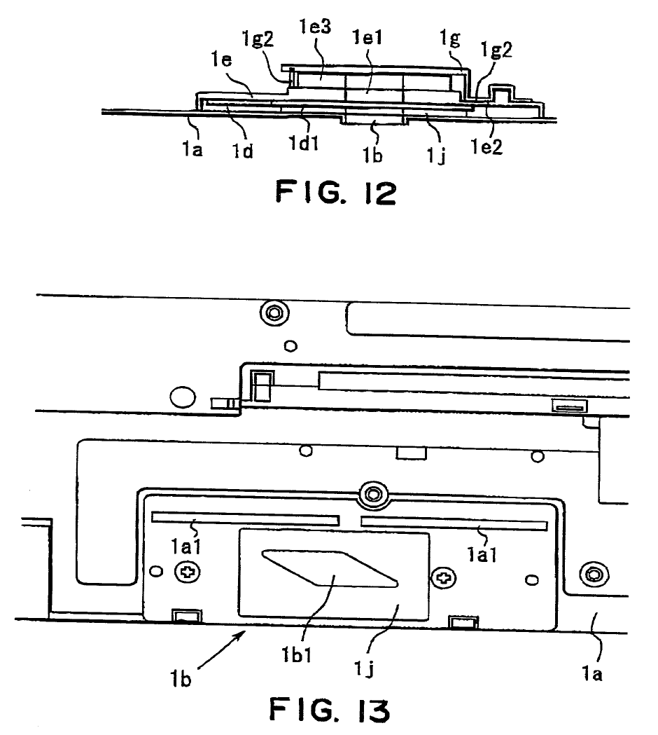

FIG. 12 is a longitudinal sectional view of the device shown in FIG. 21, (a), as seen from the top side. A seal member 1 is provided on the inlet hole 1b1 formed in the frame 1a, and an inlet hole shutter 1d is provided further thereon. The inlet hole shutter 1d is movably supported on the frame 1a by the first pushing member 1e, and an inlet hole cover 1g is movably mounted so as to cover the seal member 1e3 provided on the first pushing member 1e.

Referring to FIG. 21, the description will be made as to operational relationship between the inlet hole cover 1g and the shutter opening and closing cam 1h. In FIG. 21, the shutter opening and closing cam 1h is not shown in detail, and the center of rotation 1h3 of the shutter opening and closing cam 1h and pin 1h2 only are shown schematically.

In (a) of FIG. 21, the inlet hole cover 1g closes the opening 1e1 (inlet hole 1b1). The inlet hole cover 1g is provided in the back side with a groove 1g which is linearly extended in the longitudinal direction, and a pin 1h2 formed on the shutter opening and closing cam 1h is movably engaged with the groove 1g1. As shown in FIGS. 16 and 21, (a), when the inlet hole cover 1g closes the opening 1e1 (inlet hole 1b1), the pin 1b2 is disposed substantially at the center portion of the groove 1g1.

As shown in FIGS. 17 and 21, (b), when the shutter opening and closing cam 1h rotates in the clockwise direction about the center pin 1h3, the pin 1h2 moves along the circumference, and the inlet hole cover 1g moves upward in the Figure with the movement of the pin 1h2 in the circumferential direction. The pin 1h2 lifts the inlet hole cover 1g while moving in the groove 1g1 toward the left side in the longitudinal direction (leftward in FIG. 21).

With the rotation of the shutter opening and closing cam 1h, the pin 1h2 movement along the circumferential direction, in response to which the inlet hole cover 1g moves upwardly as shown in FIGS. 18 and 21, (c). The pin 1h2 lifts the inlet hole covering while moving to the righthand side in the longitudinal direction (to the righthand side in FIG. 21), so as to open the opening 1e1 formed in the first pushing member 1e.

When the opening 1e1 is closed by the inlet hole cover 1g from the state shown in (c) of FIG. 21, the shutter opening and closing cam 1h is rotated in the counterclockwise direction, by which the inlet hole cover 1g lowers in the Figure to close the opening 1e1, conversely to the foregoing.

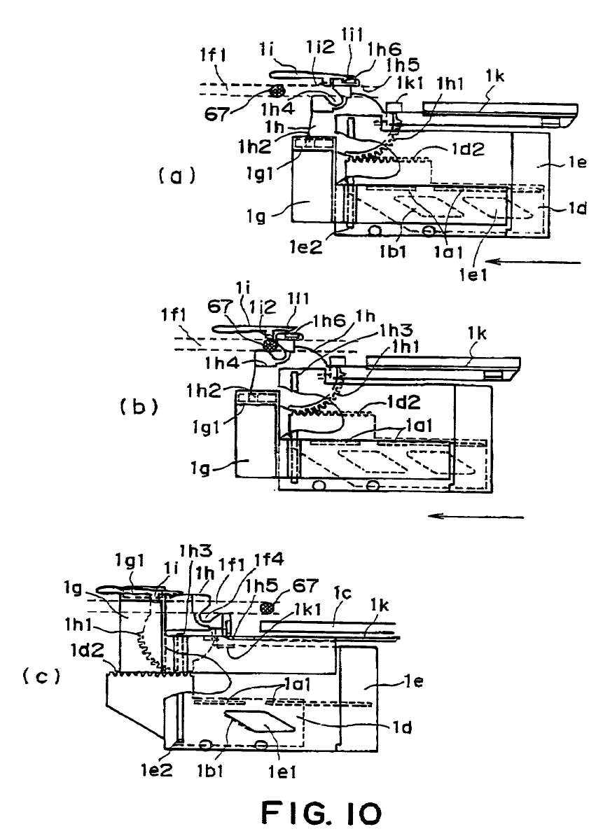

As shown in FIG. 7, the inlet hole covering is provided thereon with a second pushing member 1f (batched portion) to prevent disengagement of the inlet hole cover 1g. The second pushing member 1f is provided with a slit 1f1 which it extended linearly in the longitudinal direction. When the process cartridge 1 is mounted to the main assembly 100 of the apparatus, the slit 1f1 is passed by a pin 67 projected in the main assembly 100 of the apparatus, as will be described hereinafter. The second pushing member 1f is provided with a claw 1i1 for engagement with the shutter opening and closing cam 1h the prevent rotation of the cam 1h and a locking member 1i having a releasing portion 1i2 for releasing the engagement (FIG. 10).

As shown in FIG. 10, before the process cartridge 1 is mounted to the main assembly 100 of the apparatus, the claw 1i1 is engaged in the engaging portion (groove) 1h6 of the cam 1h, therefore, the cam 1 is locked (FIG. 10 (a)). When the process cartridge is inserted, the pin provided in the main assembly of the apparatus is abutted to the releasing portion to disengage the claw from the engaging portion (FIG. 10 (b)), and with further insertion of the process cartridge, the pin is brought into engagement with the cam, thus rotating the cam FIG. 10 (c)).

As described in the foregoing, the rotating operation of the shutter opening and closing cam 1h accomplishes three actions, namely, opening and closing operations of the inlet hole shutter 1d, the laser shutter 1k and the inlet hole cover 1g. Before the start of use of the process cartridge 1, the inlet hole shutter 1d takes the first position in which the inlet hole shutter 1d is closely contacted to the seal member 1j of the opening 1b, so that inlet hole 1b1 disclosed. Also, the inlet hole cover 1g is at the first position for covering the opening 1e1 formed in the first pushing member 1e, so that opening is closed.

Connecting portion of toner supply container

The description will be made as to the connecting portion of the toner supply container 5.

As shown in FIG. 2, the first opening 5f5 is formed below the screw 5a, and the first seal member 5f6 is provided below the first opening 5f5. In this embodiment, the outlet hole 5f is provided in the drive transmission side of the screw 5a, and is disposed at a rear side with respect to a inserting direction of the container.

The first sealing member 5f6 is provided to prevent toner from leaking from the edge of the first hole 5f5. It is an elastic member with a predetermined thickness, and its opening is the same in shape as that of the first hole 5f5. The first sealing member 5f6 is pasted to the peripheries of the bottom opening of the first hole 5f6, by its upwardly facing surface, with its opening in alignment with the first hole 5f5. In this embodiment, foamed urethane is used as the material for the first sealing member 5f6. However, the material choice for the first sealing member 5f6 does not need to be limited to foamed urethane; any elastic material may be used.

Below the first sealing member 5f6, a sealing plate 5f7 is located. The sealing plate 5f7 is pasted to the downwardly facing surface of the first sealing member 5f6, by its upwardly facing surface. Since the sealing plate 5f7 is supported by the first sealing member 5f6, it is allowed to move vertically or tilt within a range afforded by the elasticity of the first sealing member 5f6. The sealing plate 5f7 is provided with a third hole 5f7a, which is a through hole, and is alignment with the first hole 5f5. In other words, the toner outlet portion 5f is contrived so that the toner falls through the first hole 5f5, hole of the first sealing member 5f6, and third hole 5f7a of the sealing plate 5f7 in this order.

The bottom portion of the toner supply container 5 is provided with the toner outlet hole shutter 5f3 for opening or closing the first hole 5f5, and the toner outlet hole shutter holding member 5f2 which prevents the toner outlet hole shutter 5f3 from falling off, as well as connecting between the first hole 5f5 and the toner inlet 1b of the process cartridge 1. Referring to FIG. 2, the toner outlet hole shutter 5f3 is located below the sealing plate Sf7, and a second sealing member 5f8 is sandwiched between the toner outlet hole shutter 5f3 and sealing plate 5f7. The second sealing member 5f8 is for preventing toner from leaking from the peripheries of the opening of a second hole 5f3b, with which the toner outlet hole shutter 5f3 is provided, and which will be described later. It is an elastic member, and is disposed so that its hole aligns with the second hole 5f3b. The second sealing member 5f8 is pasted to the toner outlet hole shutter 5f3 by its downwardly facing surface, but its upwardly facing surface is not fixed to the downwardly facing surface of the sealing plate 5f7, being allowed to slide against the sealing plate 5f7. As for the material for the second sealing member 5f8, such substances that have elasticity and are low in the friction against the sealing plate 5f7, are preferable. More specifically, a sheet of foamed urethane, or a sheet of foamed urethane to which a low friction sheet has been pasted, or the like, may be used.

The bottom surface portion of the toner supply container 5 is further provided with an outlet hole cover 5f1 which covers the pushing member 5f2 and which is movable in the longitudinal direction.

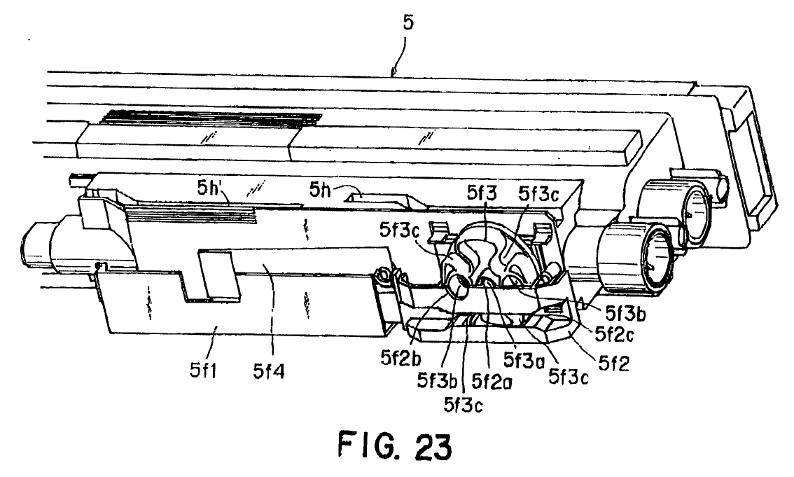

FIG. 23 is an enlarged perspective view of the toner outlet cover and toner outlet hole shutter portions of the toner supply container 5, as seen diagonally below the bottom, rear, right corner of the toner supply container 5. In the drawing, the halves of the toner outlet cover 5f1 and shutter holding member 5f2, with respect to their center lines parallel to the lengthwise direction of the toner supply container 5, have been removed for visual confirmation. As shown in the drawing, the toner outlet hole shutter 5f3 rotates about a rotational axis 5f3a. It has two second holes 5f3b symmetrically located with respect to the rotational axis 5f3a, and four slits 5f3c, which are engagement portions for rotating the shutter. The positions of the four slits 5f3c are offset from the adjacent second holes 5f3b by 45 degrees.

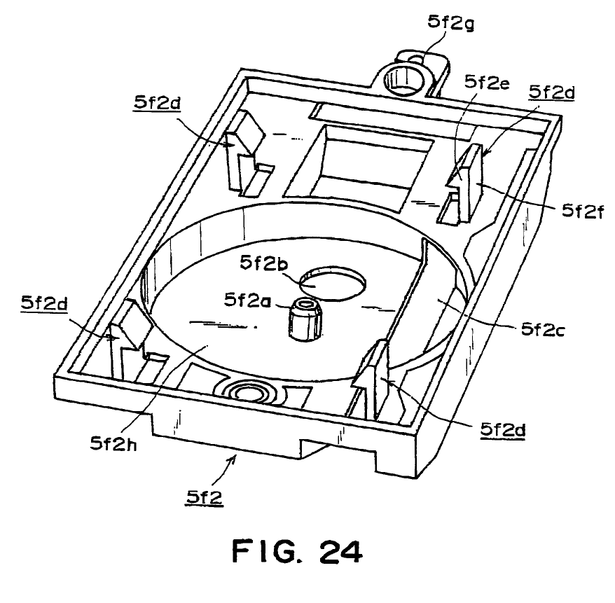

Referring to FIG. 24, the shutter holding member will be described. FIG. 24 is a perspective view of the shutter holding member 5f2, which has been removed from the toner supply container 5. The shutter holding member 5f2 is provided with a pin 5f2a, which constitutes the rotational axis for rotationally supporting toner outlet hole shutter 5f3, a fourth hole 5f2b, that is, a through hole through which toner is supplied, and a slit 5f2c which extends approximately straight in the lengthwise direction of the shutter holding member 5f2. The pin 5f2a perpendicularly projects from the upwardly facing surface of the bottom wall 5f2h of the shutter holding member 5f2. The pin 5f2a rotationally supports the toner outlet hole shutter 5f3 by being fitted in the center hole 5f3a of the toner outlet hole shutter 5f3. The four corners of the shutter holding member 5f2 are provided with a pawl 5f2d, which projects upward. As the shutter holding member 5f2 is attached to the bottom plate 5i of the toner supply container 5 as shown in FIG. 2, each pawl 5f2d fits into the corresponding hole 5i1 in the bottom plate 5i, and the claw 5f2e of the pawl 5f2d, which projects inward of the pawl 5f2, catches the bottom plate 5i, locking the shutter holding member 5f2 to the bottom plate 5i in a manner of being hung from the bottom plate 5i.

The arm portion 5f2f of the pawl 5f2d is rendered long enough for the shutter holding member 5f2 to be kept pressed downward by the resiliency of the first sealing member 5f6. Further, the pawl 5f2d is fitted in the hole 5i1 of the bottom plate 5i with the presence of a certain amount of play so that the shutter holding member 5f2 is allowed to move left or right, or tilt, relative to the bottom plate 5i. In other words, the shutter holding member 5f2 is attached to the bottom plate 5i of the toner supply container 5 with the presence of a certain amount of play so that the shutter holding member 5f2 is allowed to move vertically, left or right, or tilt, relative to the bottom plate 5i. Consequently, the shutter holding member 5f2 is allowed to slightly move vertically, left, or right, or tilt, relative to the shell 5g.

Further, the shutter holding member 5f2, toner outlet hole shutter 5f3, and sealing plate 5f7 are enabled to slightly move together vertically, left or right, or slightly tilt, relative to the shell 5g.

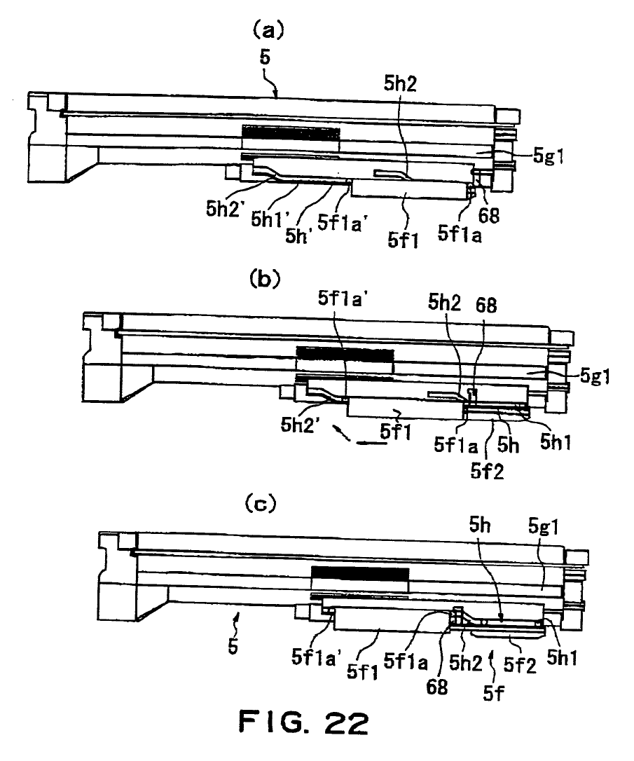

As shown in FIG. 22, the toner supply container 5 is provided with the toner outlet cover 5f1, which is attached to the toner supply container 5 in such a manner that the toner outlet cover 5f1 is enabled to cover the above described shutter holding member 5f2, to be moved by the grooves 5h and 5h′ of the toner supply container 5 toward the trailing and of the toner supply container 5 in terms of the toner supply container insertion direction, and to be retracted upward also by the grooves 5h and 5h′ prior to the mounting of the toner supply container 5 into tne apparatus main assembly 100, the second hole 5f3b of the toner outlet hole shutter 5f3 is at the first position, which is 90 degrees apart in terms of the rotational phase of the toner outlet hole shutter 5f3 from the position of the first hole 5f5, and first hole 5f5 is closed by the toner outlet hole shutter 5f3. The shutter holding member 5f2 is provided with a hook 5f2g on which one of the tension spring 67 is hung, and the toner outlet cover 5f1 is kept under the pressure generated by the tension spring 67 in the direction to keep the shutter holding member 5f2 at the first position where the toner outlet cover 5f1 covers the shutter holding member 5f2.

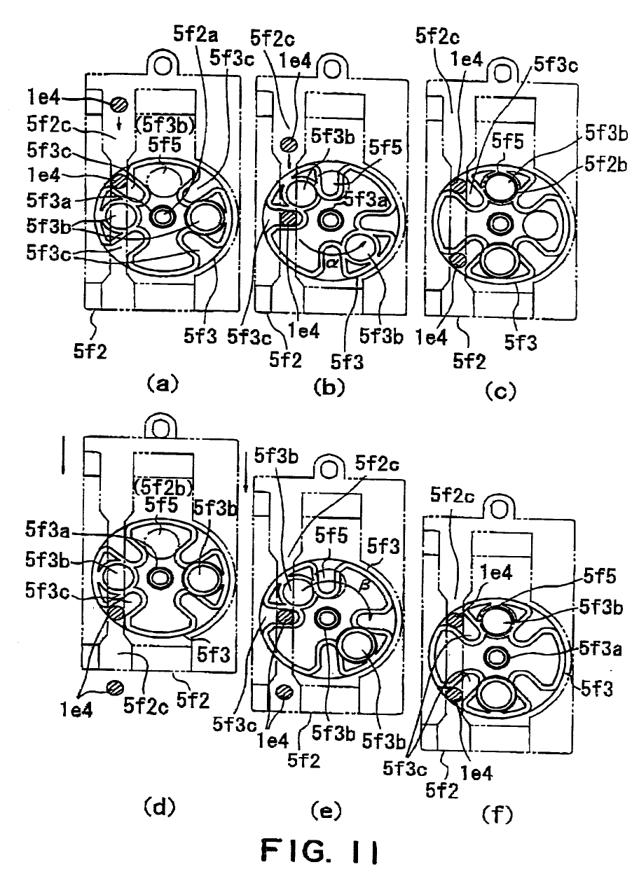

FIG. 11 is a portion enlarged view of an outlet hole 5f of the toner supply container as seen from the bottom side. For better illustration, the pushing member 5f2 is indicated by chain lines with two dots.

As shown in FIG. 11, the outlet hole shutter 5f3 has a center of rotation 5f3a, and is provided with second opening 5f3b se respective positions which are a symmetrical with respect to the center of rotation 5f3a, and with four slit 5f3c se positions 45° away from the second openings 5f3b.

As described in the foregoing, the pushing member 5f2 is provided with a pin 5f2a for rotatably the outlet hole shutter 5f3 by engagement with the center of rotation 5f3a of the outlet hole shutter 5f3, the fourth opening 5f2b for toner supply formed in the position in alignment with the first opening 5f5, and a longitudinally extending slit 5f2c.

Before the start of use of the toner supply container 5, the second opening 5f3b of the outlet hole shutter 5f3 takes the first position which is 90° away from the first opening 5f5 (fourth opening 5f2b), so that first opening 5f5 is closed. The outlet hole cover 5f1 is urged to a position covering the pushing member 5f2, by a shown spring or the like.

The description will be made as to opening and closing operations of the toner inlet hole shutter, the laser shutter and the toner inlet hole cover provided in the process cartridge 1.

The mounting operation of the process cartridge 1 to the main assembly 100 of the apparatus will first be described.

As shown in FIG. 10, (a), the main assembly 100 of the apparatus is provided with a pin 67 in an insertion path of the process cartridge 1. When the process cartridge 1 is inserted into the main assembly 100 of the apparatus, the pin 67 passes to the right in the linear slit 1f1 formed in the second pushing member 1f. As shown in FIG. 10, (b), when the process cartridge 1 is inserted into the main assembly 100 of the apparatus, the pin 67 is first abutted to the releasing portion 1i2 the locking member 1i provided on the second pushing member 1f so that engagement between the claw 1i1 of the locking member 1i and the engaging portion 1h6 of the shutter opening and closing cam 1h is released.

Then, the pin 67 is engage with the cam portion 1h4 formed in the shutter opening and closing cam 1h. With further insertion of the process cartridge 1, the shutter opening and closing cam 1h starts to rotate above the center of rotation 1h3. When it is completely inserted to the mounting position, the shutter opening and closing cam 1h rotates to the second position as shown in FIG. 10, (c) and in FIG. 18. The above-described inlet hole shutter 1d and the inlet hole cover 19 is interrelated with the rotation of the shutter inlet hole cover 1g inlet hole shutter 1d, so that inlet hole shutter 1d moves in the longitudinal direction (to the left in FIG. 10, (c)), and inlet hole cover 1g moves in the orthogonal direction (to the top in FIG. 10 (c)). By the exposure of the inlet hole 1b1 in this manner, the toner supply into the process cartridge 1 is enabled.

The laser shutter 1k is opened in interrelation with the rotation of the shutter opening and closing cam 1h.

When the process cartridge 1 is taken out of the main assembly 100 of the apparatus, the pin 67 provided in the main assembly 100 of the apparatus is relatively moved to the left relative to the process cartridge 1 as shown in FIG. 10, (c). Then, the pin 67 is brought into engagement with the cam portion 1h4 provided in the shutter opening and closing cam 1h to rotate the shutter opening and closing cam 1h in the counterclockwise direction.

As shown in FIG. 10, (b), in interrelation with the rotation of the shutter opening and closing cam 1h, the inlet hole shutter 1d moves in the longitudinal direction (rightward in FIG. 10 (b)), and the inlet hole cover 1g moves in the direction perpendicular to the longitudinal direction (downward in FIG. 10, (b)).

When the shutter opening and closing cam 1h is rotated to the position where the pin 67 and the cam portion 1h4 of the shutter opening and closing cam 1h are disengaged from each other, as shown in FIG. 10, (a), the inlet hole shutter 1d closes the inlet hole 1b1, and the inlet hole cover 1g closes the opening 1e1. In interrelation with the rotation of the shutter opening and closing cam 1h, the laser shutter 1k is closed, and the exposure opening 1c is closed by the laser shutter 1k. The engaging portion 1h6 of the shutter opening and closing cam 1h is engaged with a claw 1i1 of the locking member 1i provided in the second pushing member 1f to lock rotation of the shutter opening and closing cam 1h.

The description will be made as to the opening and closing operations of the toner outlet hole shutter 5f3 and the toner outlet hole cover 5f1 provided in the toner supply container 5.

As shown in FIG. 22, (a), the main assembly 100 of the apparatus is provided with a projection 68 in an insertion path of the toner supply container 5, and when the toner supply container 5 is inserted, the projection 68 is abutted to the outlet hole cover 5f1 described in the foregoing.

With the further insertion of the toner supply container 5 as shown in FIG. 22, (b), the outlet hole cover 5f1 is led on the rail 5h formed in the toner supply container 5, and is moved in the direction away from the toner supply container 5 virtually. When the toner supply container 5 is mounted to the main assembly 100 of the apparatus, the outlet hole 5f is opened as shown in FIG. 22, (c).

FIG. 11 is a drawing for showing the operational stages of the toner outlet hole shutter 5f3. FIGS. 11(a)-11(c) show the stages through which the process cartridge 1 is inserted into the apparatus main assembly 100 in which the toner supply container 5 has already been mounted, whereas FIGS. 11(d)-11(f) show the stages through which the toner supply container 5 is inserted into the apparatus main assembly 100 in which the process cartridge 1 has already been mounted.

Referring to FIGS. 11(d)-11(f), when the process cartridge 1 has already been mounted in the apparatus main assembly 100, the two guide pins 1e4 are not movable. As the toner supply container 5 is inserted in the direction indicated by an arrow mark in the drawing, the guide pin 1e4 of the process cartridge 1 on the front side engages into the slit 5f3c of the toner outlet hole shutter 5f3 (FIG. 11(d)). In this state, the first hole 5f5 is closed by the toner outlet hole shutter 5f3, because the position of the second hole 5f3b is 90 degrees apart from the position of the first hole 5f5 (fourth hole 5f2b) in terms of the rotational phase of the toner outlet hole shutter 5f3.

As the toner supply container 5 is further inserted, the toner outlet hole shutter 5f5 begins to be rotated in the direction indicated by an arrow mark about the rotational axis 5f3a (FIG. 11(e)). By the time the toner supply container 5 is inserted to its final mounting position, the toner outlet hole shutter 5f3 is rotated to the position shown in FIG. 11(f), at which the first hole 5f5 (fourth hole 5f2b) of the toner supply container 5 aligns with the second hole 5f3b of the toner outlet hole shutter 5f3, allowing the toner to be discharged.

In comparison, referring to FIGS. 11(a)-11(c), when the toner supply container 5 has already been mounted in the apparatus main assembly 100, the toner outlet hole shutter 5f3 has not rotated, and is rotatable as the process cartridge 1 is inserted in the direction indicated by an arrow mark in the drawing, the guide pin 1e4 of the process cartridge 1, on the leading end of the process cartridge 1 in terms of the process cartridge insertion direction, engages into the slit 5f3c of the toner outlet hole shutter 5f3 (FIG. 11(a)). In this state, the first hole 5f5 is closed by the toner outlet hole shutter 5f3, since the position of the second hole 5f3b is 90 degrees apart from the position of the first hole 5f5 (fourth hole 5f2b) in terms of the rotational phase of the toner outlet hole shutter 5f3.

As the process cartridge 1 is further inserted, the toner outlet hole shutter 5f3 begins to be rotated in the direction indicated by an arrow mark ? about the rotational axis 5f3a (FIG. 11(b)). By the time the process cartridge 1 is inserted to its final mounting position, the toner outlet hole shutter 5f3 is rotated to the position shown in FIG. 11 (c), at which the first hole 5f5 (fourth hole 5f2b) of the toner supply container 5 aligns with the second hole 5f3b f the toner outlet hole shutter 5f3, allowing the toner to be discharged.

When the process cartridge 1 and toner supply container 5 are in the state shown in FIGS. 11(c) and 11(f), the first hole 5f5 of the toner supply container 5 and the toner inlet hole 1b1 of the process cartridge 1 are in alignment with each other, which is obvious.

Further, the shutter holding member 5f2 is attached to the bottom plate 5i of the toner supply container 5 in such a manner that it is allowed to make slight vertical movement and/or tilt relative to the bottom plate 5i as described above. Therefore, while the toner supply container 5 or process cartridge 1 is inserted, the shutter holding member 5f2 makes slight vertical movement and/or tilts to conform to the shape of the sealing member 1e3 (FIG. 10) to remain airtightly in contact with the sealing member 1e3. Therefore, toner does not scatter outward of the container.

Incidentally, if the toner outlet hole shutter 5f3 is the only structural component for preventing toner from leaking from the toner outlet portion 5f, it is impossible to completely prevent the toner particles, which have adhered to the wall of the second hole 5f3b of the toner outlet hole shutter 5f3, from leaking. Further, if the toner outlet cover 5f1 is the only structural component for preventing the toner leakage, there is a possibility that the toner leakage will occur, since the toner outlet cover 5f1 might be moved to its open position due to the operational errors or the like by a user.

However, according to the present invention, the toner supply container 5 is provided with both the toner outlet hole shutter 5f3 and toner outlet cover 5f1. In other words, the toner leakage preventing means is given a fail-safe structure. Therefore, the toner particles which have adhered to the wall of the second hole 5f3b do not leak outward since they are prevented by, the toner outlet cover 5f1 from leaking outward. Further, there is no possibility that the toner outlet portion 5f will be exposed due to the operational error or the like, since the slits 5f3c, that is, the engagement portions, for rotationally driving the toner outlet hole shutter 5f3 are covered with the toner outlet cover 5f1.

In this embodiment, the inlet hole shutter 1d of the process cartridge 1 moves in the longitudinal direction, the inlet hole cover 1g moves in the direction substantially perpendicular to the longitudinal direction. The reason will be described. The inlet hole shutter 1d is constructed so as to prevent leakage of the toner by the seal member 1j, and therefore, in order to move the inlet hole shutter 1d, a force larger than the sliding resistance relative to the seal member 1j. However, if an attempt is made to move the inlet hole shutter 1d in the direction substantially perpendicular to the longitudinal direction, it tends to incline due to the sliding resistance with the seal member 1j with possible result of unsmooth opening and closing operations.

On the other hand, the inlet hole cover 1g is moved in the direction substantially perpendicular to the longitudinal direction, since otherwise it is interfered with the outlet hole 5f of the toner supply container 5, or it is contaminated with the toner, since the movement path of the outlet hole 5f of the toner supply container 5 is in the longitudinal direction.

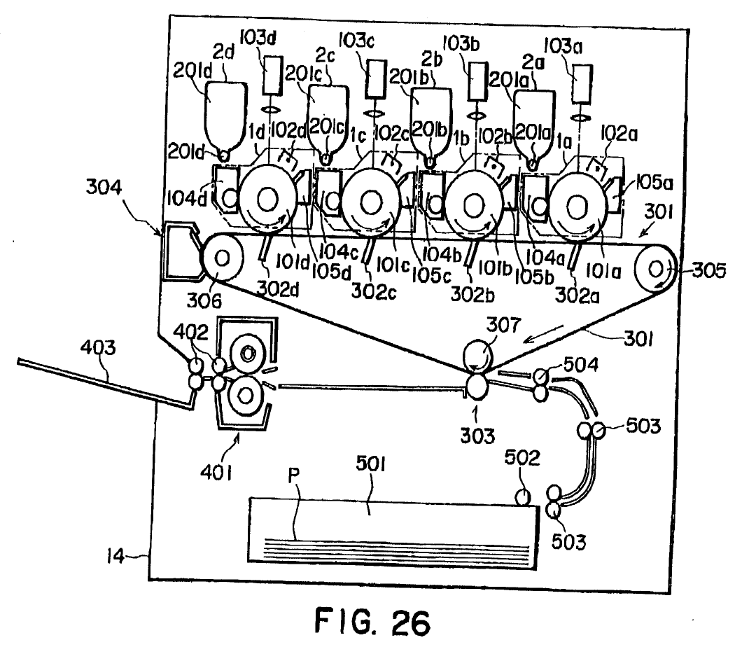

The description will be made as to embodiment 2. FIG. 26 is a schematic sectional view of a color electrophotographic printer as an exemplary image forming apparatus according to this embodiment of the present invention.

The color electrophotographic printer shown in FIG. 26 is provided with a process cartridge 1 (1a, 1b, 1c, 1d) independently detachably mountable to the main assembly and a developer container in the form of a cartridge (toner cartridge 2 (2a, 2b, 2c, 2d)).

Around the photosensitive drum 101 (image bearing member (101a, 101b, 101c, 101d)), there are provided a charging device 102 (102a, 102b, 102c, 102d) for uniformly charging a surface of the photosensitive drum 101, an exposure device 103 (103a, 103b, 103c, 103d) for protecting image information onto the photosensitive drum 101 with a laser beam, a developing device 104 (104a, 104b, 104c, 104d) for visualizing an electrostatic latent image on the photosensitive drum 101, a primary transfer charger 302 (302a, 302b, 302c, 302d) for transferring the toner image from the surface of the photosensitive drum 101 onto an intermediary transfer member 301, and a cleaning device 105 ( 105a, 105b, 105c, 105d) for removing and collecting residual toner from the surface of the photosensitive drum 101. There are further provided a secondary transferring device 303 for transferring the toner image transferred onto the intermediary transfer member 301 onto a transfer material P (recording material), an intermediary transfer member cleaning device 304 for removing residual toner from the intermediary transfer member 301, a fixing device 401 for image fixing process, a discharging roller for discharging 402 the transfer material P after the fixing process, and a sheet discharge tray 403 for stacking the transfer material after it is discharged. The intermediary transfer member 301 is made of dielectric film and is extended around a driving roller 305, a follower roller 306 and a secondary transfer opposing roller 307, and the portion thereof stretched between the driving roller 305 and the follower roller 306 is contacted to the photosensitive drums 101a, 101b, 101c, 101d. It is rotated in the direction indicated by the arrow.

The toner cartridge 2 (developer container) comprises a toner accommodating portion 201 (201a, 201b, 201c, 201d) which accommodates the toner. When a toner supply signal is produced by toner amount detecting means (unshown) of the developing means, the toner supplying screw 202 (202a, 202b, 202c, 202d) rotates to supply the toner.

The transfer materials P (the said recording materials) are stacked in a sheet feeding cassette 501 and are fed out in seriatim by a sheet feeding roller 502 and is fed by the feeding roller 503 to the registration rollers 504 which feeds the transfer material to the photosensitive drum 101 in synchronism with the toner image. The sheet feeding cassette 501 shown in FIG. 26 has a single stage structure. However, it may view of a multistage structure to accommodate different size transfer materials in the same or different orientations so as to facilitate selection of the transfer materials.

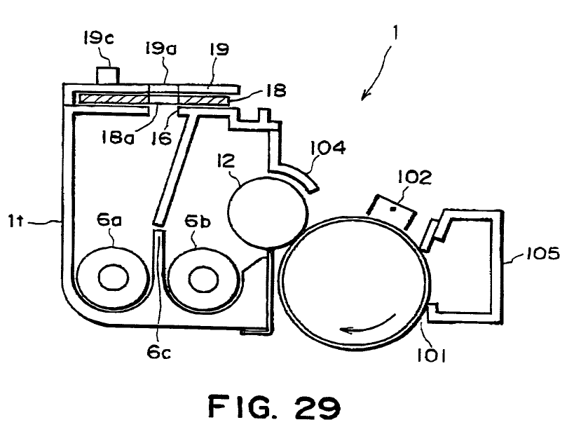

The developing device 104 comprises a developing roller, a developing blade and a feeding screw in a process cartridge container (developing container, FIG. 29) 1t. The electrostatic latent image formed on the photosensitive drum 101 is developed by the developing roller. More particularly, the toner in the process cartridge container (developing container) 1t is applied on the outer periphery of the developing roller 12 in the form of a thin layer, and is electrically charged by a developing blade. When the amount of the toner in the developing container decreases, an unshown sensor detects the event, and the toner is supplied from the toner cartridge 2 into the developing container 1t through a receiving port 16. The toner fed into the developing container 1t is fed by the feeding screw 6a in the direction perpendicular to the sheet of the drawing of FIG. 29. The opposite and portions of the partition 6c between the parallel screws 6b provide communicating portions for between the spaces accommodating the screws 6a, 6b. At one end portion of the partition 6c, the toner fed to the end of the other screw 6b is fed back by the screw 6b, and is returned to the screw 6a at the other end of the partition, thus circulating the toner.

The image forming process in the color electrophotographic printer is the same as with a known process, and therefore, the detailed description thereof is omitted for simplicity.

Each of the process cartridges 1a, 1b, 1c, 1d contains the photosensitive drum 101a, 101b, 101c, 101d, the charging device 102a, 102b, 102c, 102d, the developing device 104a, 104b, 104c, 104d and the cleaning device 105a, 105b, 105c, 105d. Each of the toner cartridges 2a, 2b, 2c, 2d contains the toner accommodating portion 201a, 201b, 201c, 201d, and the toner supplying screw 202a, 202b, 202c, 202d.

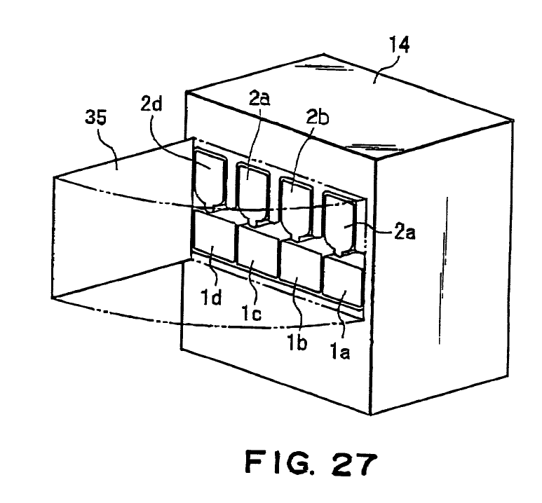

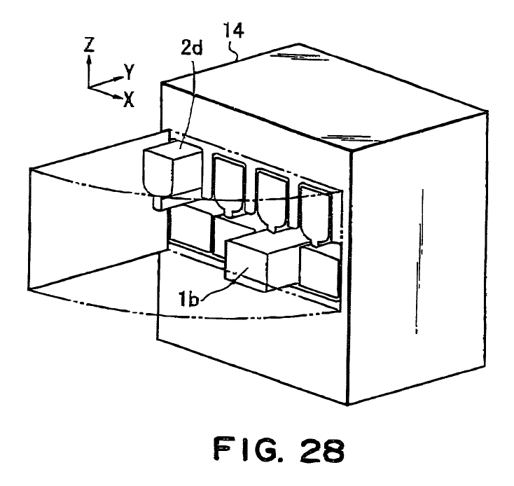

FIGS. 27 and 28 are schematic perspective views of the color electrophotographic printer. FIG. 27 illustrates the state in which the front side cover 35 is opening, and FIG. 28 show a stake in which the process cartridge 1 and the toner cartridge 2 are on the way of mounting to the main assembly. The process cartridge 1a, 1b, 1c, 1d and the toner cartridge 2a, 2b, 2c, 2d are detachably mounted to the main assembly 14 of the color electrophotographic printer along an unshown guiding rail in a direction Y. The photosensitive drum 101 is extended in parallel with the Y direction.

FIG. 29 illustrates a cross-section of a neighborhood of a shutter of the process cartridge 1 (P shutter) 18. In the state shown in FIG. 29, the communication port 19a of the P shutter cover 19 fixed on the process cartridge 1 and the communication port 18a of the P shutter 18 are aligned with each other, that is, the toner supply from an unshown toner cartridge is enabled.

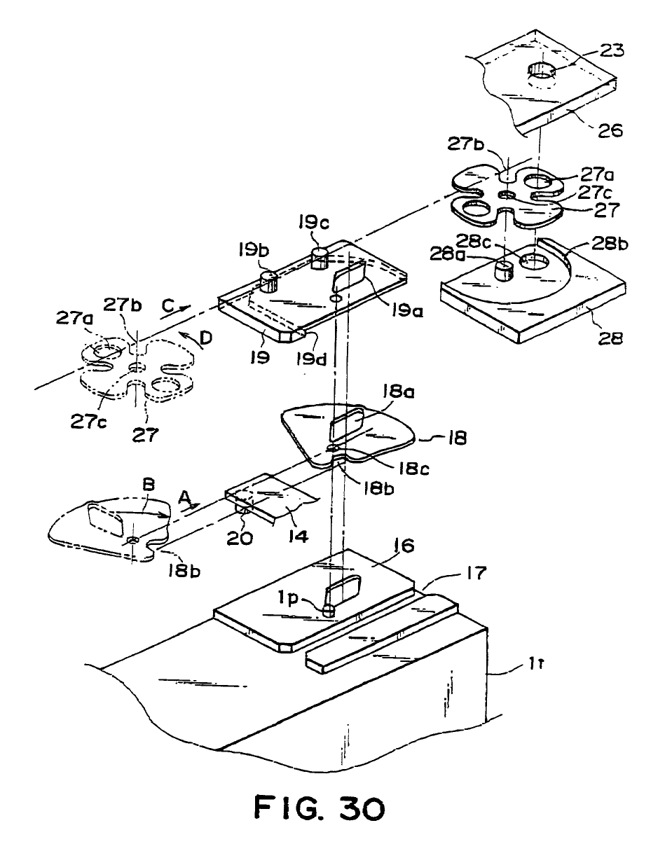

FIG. 30 is a schematic perspective view of a neighborhood of shutters of the toner cartridge and the process cartridge. A toner receiving port 16 (FIG. 29) is formed in the upper surface of the process cartridge container 1t which is a developing container constituting a frame of the developing device 104 of the process cartridge 1. The toner is supplied from here into the developing device 104. In the toner receiving port 16, there is a center hole 18c of the P shutter 18, in which a pin 1p provided on the process cartridge container 1t adjacent the toner receiving port 16, is rotatably engaged. The P shutter 18 is generally in the form of a sector man is provided with a communication port 18a, U groove 18b, a communication port 18a, U groove 18b and a center hole 18c. Outside the P shutter 18, there is provided a P shutter cover 19. The P shutter cover 19 is fixed on the upper surface of the process cartridge container 1t, and the P shutter 18 is accommodated in a recess 19d formed therein. The U groove 18b of the P shutter 18 is outside of the recess 19d of the P shutter cover 19. The P shutter cover 19 is provided with a communication port 19a, and two cylindrical projections 19b, 19c. On an extension of a demounting direction (Y direction in FIG. 28) of the U groove 18b, there is provided a projection 20 engageable with the U groove 18b in the main assembly 14 of the apparatus. On the upper surface of the process cartridge container 1t, there is formed a rail 17 to be guided by the projection 20 during the mounting-and-demounting operations of the process cartridge 1. By the rail 17 being guided, the relative positional deviation between the process cartridge 1 and projection 20 in the lateral direction (X direction in FIG. 28) can be reduced.

On the other hand, at the toner outlet hole 23 of the toner cartridge 2, there is provided a substantially circular shutter (T shutter) 27 which has a center concentric with the center hole 27c. The T shutter 27 is provided with groove portion 27b at each of quartering positions. Between adjacent groove portions 27b, there are openings 27a. The openings 27a are provided only at two positions diametrically opposite with respect to the center hole 27c.

The T shutter 27 of the toner cartridge 2 which to a rotatable shutter is disposed along the bottom portion 26 of the container of the toner accommodating portion 201 provided in the toner cartridge 2. To the bottom portion 26 of the container, a T shutter supporting member 28 is fixed. The supporting member 28 is provided with a circular recess 282b for snug fitting with a part of the T shutter 27. A shaft 28a is provided the center of the recess 28b. A toner outlet hole 28c is provided concentrically with the toner outlet hole 23. The groove portions 27b of the T shutter 27 are outside the recess 28b while the T shutter 27 is rotating through 90°.

The T shutter 27 is rotatably supported by the engagement between the shaft 28a and the center hole 27c. When the toner cartridge 2 is inserted into the main assembly 14 of the image forming apparatus (in the direction indicated by an arrow C), the T shutter 27 taking the position indicated by the chain line, disposed at the bottom portion 26 of the container in the toner cartridge 2 is rotated about the shaft 28a (in the direction indicated by an arrow D) by engagement between the groove portion 27b and the projection 19b of the process cartridge 1 into the state indicated by the solid line, thus opening the toner outlet hole 23. The shaft 28a is disposed at a front side of the toner outlet hole 23 with respect to the inserting direction of the toner cartridge 2 into the main assembly 14 of the apparatus.

In the foregoing, the description as to a seal member for preventing toner scattering has been omitted. However, urethane foam, felt or the like may be sandwiched between the P shutter 18 and the P shutter cover 19 and/or between the T shutter 27 and the T shutter to improve the sealing performance. The sealing performance may be improved by bonding a seal member on the upper surface of the P shutter cover 19 and on the lower surface of the T shutter supporting member 28.

The T shutter 27 is opened and closed by the relative movement between the process cartridge 1 and the toner cartridge 2 in the mounting-and-demounting direction (direction Y). Thus, both when the process cartridge 1 is in the main assembly 14 of the image forming apparatus, and the toner cartridge 2 is inserted in this state and when the process cartridge 1 is inserted after the toner cartridge 2 is inserted into the main assembly 14 of the image forming apparatus, the groove portion 27b of the T shutter 27 is engaged with either one of the projections 19b, 19c of the P shutter cover 19, so that opening and closing operation of the T shutter 27 is properly opened and closed. Therefore, if the process cartridge 1 is not mounted to the main assembly 14 of apparatus, the T shutter 27 does not operate, and therefore, the toner outlet hole 23 is kept closed even if the toner cartridge 2 is inserted into the main assembly 14 of the apparatus.

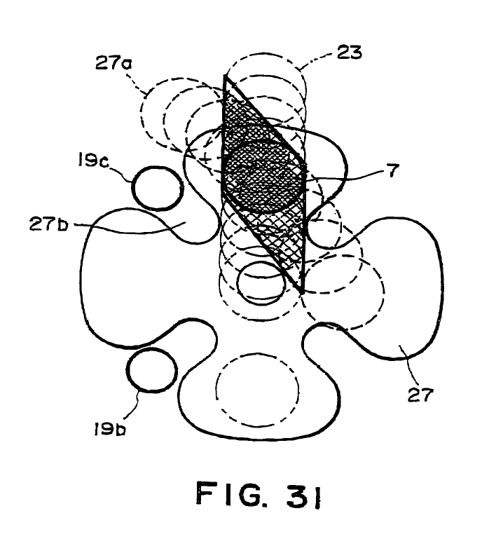

FIG. 31 shows a change of the configuration of the communicating portion defined by the communication port 18a of the P shutter 18 and the opening 27a of the T shutter 27 with the rotating operation of the T shutter 27. As described in the foregoing, the T shutter 27 is opened and closed by the relative motion between the process cartridge 1 and the toner cartridge 2 in the inserting and removing the directions. FIG. 31 illustrates the case in which the process cartridge 1 is fixed, and the toner cartridge 2 is moved in the inserting and removing directions. The circles indicated by the chain lines of represent a track of the toner outlet hole 23, and circles indicated by broken lines represent a track of the opening 27a. The outer shape of the T shutter 27 is indicated only at the position where is overlapped with the toner outlet hole 23. The T shutter 27 is rotated in response to insertion of the toner cartridge 2, and the configuration of the communicating portion defined by the toner outlet hole 23 and the opening 27a, is substantially parallelogram 7 as indicated by the cross-hatching. A pair of sides of the substantially parallelogram 7 is substantially parallel with the inserting and removing directions of the process cartridge 1. Since the toner falls into the region of the substantially parallelogram 7, the sizes or the communication port 19a of the P shutter cover 19 and the communication port 18a of the P shutter 18 are larger than the substantially parallelogram 7 in order to properly received the falling toner. If, however, the communication ports 18a, 19a are too large, the size of the P shutter 18 has to be large so that it cannot be disposed in the upper surface of the process cartridge 1, and in addition, the distance of the movement and the operating force required by the opening and closing operation have to be large. Furthermore, the possibility of the toner scattering increases.

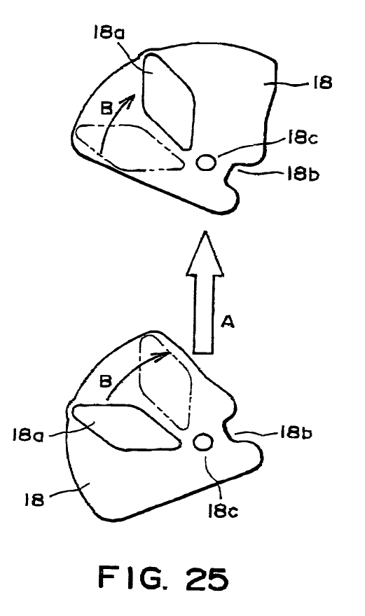

Referring to FIG. 25, the description will be made as to the P shutter 18 shown in FIG. 30. FIG. 25 is a top plan view of a P shutter disposed on the process cartridge. The inserting direction of the process cartridge 1 is as indicated by an arrow A, that is, upward in the Figure. The shown below the arrow An is in the position of closing the toner receiving port 16 (not shown in FIG. 25), and the P shutter 18 shown above the arrow An is in the position of opening it. An edge of the communication port 18a is outside the substantially parallelogram 7 by 0.2-1.2 mm.

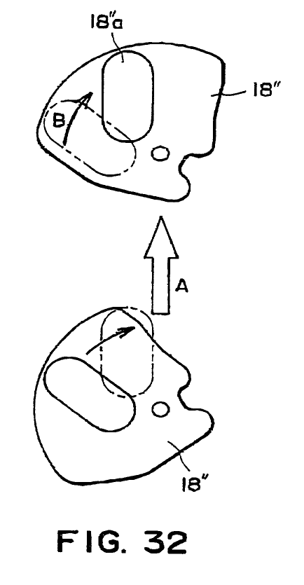

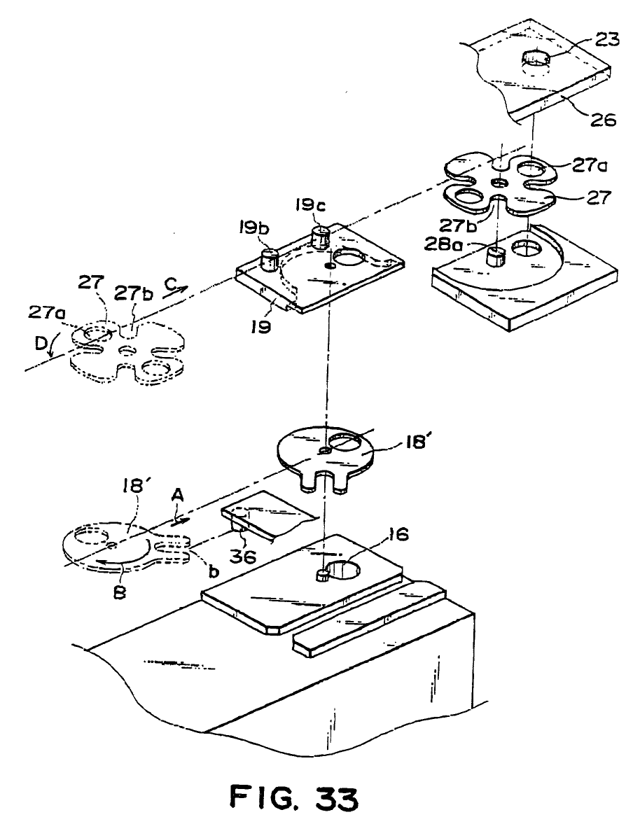

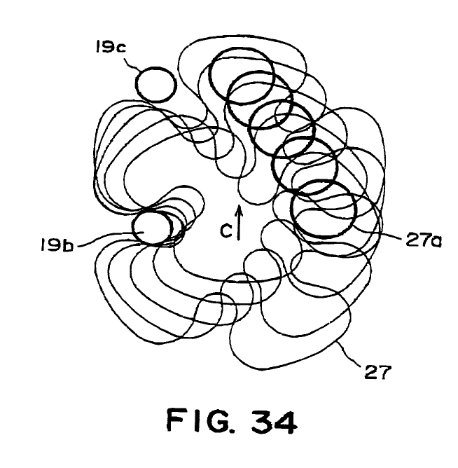

More particularly, it is larger by 0.5 mm. The rotation angle of the P shutter 18 for opening and closing the toner receiving port 16 is about 50°. The chain lines indicate open and close states. In the case that P shutter 18 has a communication port in the form of an elongated hole 18 as shown in FIG. 32, for example, the “open” and “close” indicated by the chain lines are overlapped with each other, and therefore, the rotation angle 50° as with FIG. 25 is not enough to open and close the shutter.

Because, however, the communication port 18a of the P shutter 18 is in the form of a parallelogram, and therefore, the opening and closing is complete by the rotation through 50°, and the region (area) required for the rotation of the P shutter 18 may be small, and provides a larger latitude to the P shutter 18 or another structure. Thus, the rotational range required by the opening and closing of the toner receiving port 16 of the P shutter 18 can be made smaller than 90°. A seal member or the like may be provided between the P shutter 18 and the P shutter cover 19 to improve the sealing property. The smaller rotational angle required for the opening and closing with the use of the sealing, can reduce the possibility of leakage of the toner. The center hole 18c of the P shutter 18 in this embodiment, is disposed substantially on an extension of a diagonal line of the communication port 18a. Because of this arrangement, the opening and closing the sufficient even with the small rotational angle. The process cartridge and the toner cartridge are insertable and removable independently from each other. As has been described with FIG. 31, the rotational direction of the T shutter may be clockwise or counterclockwise. Since the configuration of the communication port of the P shutter is parallelogram-like, the toner can be received irrespective of the rotational direction of the T shutter.

In the foregoing description, the example has been taken in which there are provided four process cartridges and four toner cartridges. However, this is not limiting, and the present invention is applicable to a monochromatic electrophotographic printer.

In this embodiment, the example has been taken in which the process cartridge contains the electrophotographic photosensitive drum. However, the present invention is applicable to a cartridge containing only a developing device or only a developing device plus a charging device.

While the invention has been described with reference to the structures disclosed herein, it is not confined to the details set forth and this application is intended to cover such modifications or changes as may come within the purpose of the improvements or the scope of the following claims.

What is claimed is:

1. A unit detachably mountable to an image forming apparatus, comprising:
a developer accommodating portion having a developer inlet hole;
a first opening and closing member for opening and closing said inlet hole; and
a second opening and closing member for opening and closing said inlet hole, said second opening and closing member being movable above said first opening and closing member.

2. A unit according to claim 1, further comprising a cam, operable in response to a mounting or demounting operation of said unit, for moving said first opening and closing member and said second opening and closing member.

3. A unit according to claim 1, wherein said first and second opening and closing member are moved so as to open said inlet hole when said unit is mounted to a main assembly of the image forming apparatus, and said first and second opening and closing member are moved to close said inlet hole when said unit is removed from the main assembly of the image forming apparatus.

4. A unit according to claim 1, wherein said first opening and closing member and said second opening and closing member are moved in the directions opposite from each other.

5. A unit according to claim 4, wherein said first opening and closing member is movable in a longitudinal direction of said unit, and said second opening and closing member is movable in a direction substantially perpendicular to the longitudinal direction.

6. A unit according to claim 2, further comprising a photosensitive member, an exposure opening for permitting passage of image light to said photosensitive member, a third opening and closing member for opening and closing said exposure opening, wherein said third opening and closing member is moved in accordance with a movement of said cam.

7. An image forming apparatus comprising:
an unit detachably mountable to a main assembly of said apparatus, said unit including a developer accommodating portion having a developer inlet hole and a first opening and closing member for opening and closing said inlet hole, and a second opening ad closing member, movable above said first opening and closing member, for opening and closing said inlet hole; and
an engaging portion for being contacted by a predetermined portion of said unit when said unit is mounted to the main assembly of the apparatus, wherein said opening and closing member is moved by the contact of the determined portion to said engaging portion.

8. An apparatus according to claim 7, wherein said first and second opening and closing member are moved so as to open said inlet hole when said unit is mounted to a main assembly of the image forming apparatus, and said first and second opening and closing member are moved to close said inlet hole when said unit is removed from the main assembly of the image forming apparatus.

9. A apparatus according to claim 7, wherein said unit further comprises a photosensitive member, an exposure opening for permitting passage of image light to said photosensitive member, a third opening and closing member for opening and closing said exposure opening, wherein said third opening and closing member is moved by contact to said engaging portion.

10. A unit detachably mountable to an image forming apparatus, comprising:
a developer accommodating portion having a developer inlet hole;
an opening and closing member for opening and closing said inlet hole;
wherein said inlet hole has a substantially parallelogram shape having an inner angle which is not right angle.

11. A unit according to claim 10, wherein two sides of said inlet hole are substantially parallel with a longitudinal direction of said unit.

12. An image forming apparatus comprising:
an unit detachably mountable to a main assembly of said apparatus, said unit including a developer accommodating portion having a having and an opening and closing member for opening and closing said inlet hole; and
an engaging portion for being contacted by a predetermined portion of said unit when said unit is mounted to the main assembly of the apparatus; wherein said opening and closing member is moved by the contact of the determined portion to said engaging portion;
wherein said inlet hole has a substantially parallelogram shape having an inner angle which is not right angle.

13. An apparatus according to claim 12, wherein two sides of said inlet hole are substantially parallel with a longitudinal direction of said unit.

14. An apparatus according to claim 12, further comprising a developer supply container accommodating a developer to be supplied to said unit, said developer supply container being detachably mountable to the main assembly of said apparatus, wherein said supply container includes a developer outlet hole and a shutter for opening and closing said outlet hole by relative motion between said unit and said shutter.

15. An image forming apparatus comprising:
a first unit detachably mountable to a main assembly of said operators, wherein said first unit including a developer outlet hole and a movable shutter having a hole capable of exposing said outlet hole;
a second unit detachably mountable to the main assembly of said apparatus, said second unit having a developer inlet hole for permitting passage of the developer falling from the outlet hole;
wherein said shutter is movable in response to a relative motion between said first unit and said second unit;
wherein a configuration of said inlet hole is along a track of an overlapped portion of said outlet hole and said hole which changes with mounting or demounting operation of said first or second unit.
